(19) United States
(12) Patent Application Publication
(10) Pub. No.: US 2014/0133547 A1
(43) Pub. Date: May 15, 2014

(54) IMAGE PROCESSING DEVICE AND IMAGE PROCESSING METHOD

(71) Applicant: Junichi Tanaka, Kanagawa (JP)

(72) Inventor: Junichi Tanaka, Kanagawa (JP)

(73) Assignee: Sony Corporation, Minato-ku, Tokyo (JP)

(21) Appl. No.: 14/127,438

(22) PCT Filed: May 29, 2012
(86) PCT No.: PCT/JP2012/063750

§ 371 Date: Dec. 18, 2013

(30) Foreign Application Priority Data
Aug. 30, 2011 (JP) 2011-187180
Jan. 18, 2012 (JP) 2012-007928

(51) Int. Cl. H04N 19/46

(52) U.S. Cl. CPC H04N 19/00545
USPC 375/240.02; 375/240.26

(57) ABSTRACT

There is provided an image processing device including an acquisition section that acquires, from a parameter set of an encoded stream, a parameter group including one or more parameters used when encoding or decoding an image, and a sub-identifier that identifies the parameter group, and a decoding section that decodes the image using a parameter in the parameter group that is referenced using the sub-identifier acquired by the acquisition section.

### TECHNICAL FIELD

The present disclosure relates to an image processing device and an image processing method.

### BACKGROUND ART

In H.264/AVC, one of the standard image encoding scheme specifications, two types of parameters sets called a sequence parameter set (SPS) and a picture parameter set (PPS) are defined for storing parameters used to encode and decode an image. The SPS is a parameter set primarily for storing parameters that may change for each sequence, while the PPS is a parameter set primarily for storing parameters that may change for each picture. In practice, however, many of the parameters stored in the PPS do not change over multiple pictures.

In the standards work for High Efficiency Video Coding (HEVC), a next-generation image encoding scheme to succeed H.264/AVC, the introduction of an adaptation parameter set (APS), which is a new parameter set different from the SPS and the PPS, has been proposed (see Non-Patent Literature 1 below). The APS is a parameter set primarily for storing parameters that are set adaptively for each picture. By storing parameters with a large data size that have a high chance of actually changing for each picture in the APS rather than the PPS, it is possible to use the APS to transmit only updated parameters from the encoding side to the decoding side at the right time, and avoid the redundant transmission of parameters that are not updated. According to Non-Patent Literature 1 below, parameters related to an adaptive loop filter (ALF) and a sample adaptive offset (SAO) are stored in the APS.

### CITATION LIST

### Non-Patent Literature

Non-Patent Literature 1: JCTVC-F747r3, “Adaptation Parameter Set (APS)”, Joint Collaborative Team on Video Coding (JCT-VC) of ITU-T SG16 WP3 and ISO/IEC JTC1/SC29/WG11 6th Meeting: Torino, IT, 14-22 Jul. 2011

### SUMMARY OF INVENTION

### Technical Problem

Besides the parameters related to the above ALF and SAO, there exist other parameters desirable to include in the APS rather than the PPS. Examples of such are parameters related to a quantization matrix and parameters related to an adaptive interpolation filter (AIF). If parameters with mutually different properties are included in a single parameter set, their differences in update frequency may become an impediment to the optimization of coding efficiency. On the other hand, it is not feasible to limitlessly increase the types of parameter sets.

Consequently, it is desirable to provide a mechanism capable of avoiding the redundant transmission of parameters according to update requirements, even in the case of including parameters with mutually different properties in a shared parameter set.

### Solution to Problem

According to the present disclosure, there is provided an image processing device including an acquisition section that acquires, from a parameter set of an encoded stream, a parameter group including one or more parameters used when encoding or decoding an image, and a sub-identifier that identifies the parameter group, and a decoding section that decodes the image using a parameter in the parameter group that is referenced using the sub-identifier acquired by the acquisition section.

The image processing device can be realized typically as an image decoding device for decoding an image.

According to the present disclosure, there is provided an image processing method including acquiring, from a parameter set of an encoded stream, a parameter group including one or more parameters used when encoding or decoding an image, and a sub-identifier that identifies the parameter group, and decoding the image using a parameter in the parameter group that is referenced using the acquired sub-identifier.

According to the present disclosure, there is provided an image processing device including a setting unit that sets a parameter group including one or more parameters used when encoding or decoding an image, and a sub-identifier that identifies the parameter group, and an encoding section that inserts the parameter group and the sub-identifier set by the setting unit inside a parameter set of an encoded stream generated by encoding the image.

The image processing device can be realized typically as an image encoding device for encoding an image.

According to the present disclosure, there is provided an image processing method including setting a parameter group including one or more parameters used when encoding or decoding an image, and a sub-identifier that identifies the parameter group, and inserting the set parameter group and the set sub-identifier inside a parameter set of an encoded stream generated by encoding the image.

### Advantageous Effects of Invention

According to the present disclosure, it is possible to avoid the redundant transmission of parameters in the case of including parameters with mutually different properties in a shared parameter set.

### BRIEF DESCRIPTION OF DRAWINGS

FIG. 1 is a block diagram illustrating an exemplary configuration of an image encoding device according to an embodiment.

FIG. 2 is an explanatory diagram illustrating an example of an encoded stream structured in accordance with a first technique.

FIG. 3 is an explanatory diagram illustrating an example of APS syntax defined in accordance with a first technique.

FIG. 4 is an explanatory diagram illustrating an example of slice header syntax defined in accordance with a first technique.

FIG. 5 is an explanatory diagram illustrating an example of APS syntax defined in accordance with an exemplary modification of a first technique.

FIG. 6 is an explanatory diagram illustrating an example of an encoded stream structured in accordance with a second technique.

FIG. 7A is an explanatory diagram illustrating an example of ALF APS syntax defined in accordance with a second technique.

FIG. 7B is an explanatory diagram illustrating an example of SAO APS syntax defined in accordance with a second technique.

FIG. 7C is an explanatory diagram illustrating an example of QM APS syntax defined in accordance with a second technique.

FIG. 8 is an explanatory diagram illustrating an example of slice header syntax defined in accordance with a second technique.

FIG. 9 is an explanatory diagram illustrating an example of an encoded stream structured in accordance with a third technique.

FIG. 10 is an explanatory diagram illustrating an example of APS syntax defined in accordance with a third technique.

FIG. 11 is an explanatory diagram illustrating an example of slice header syntax defined in accordance with a third technique.

FIG. 12 is a table listing parameter features for each of several typical encoding tools.

FIG. 13 is an explanatory diagram for explaining an example of an encoded stream structured in accordance with an exemplary modification of a third technique.

FIG. 14 is a block diagram illustrating an example of a detailed configuration of the syntax encoding section illustrated in FIG. 1.

FIG. 15 is a flowchart illustrating an example of a flow of an encoding process according to an embodiment.

FIG. 16 is a flowchart illustrating an example of a detailed flow of the APS encoding process illustrated in FIG. 15.

FIG. 17 is a flowchart illustrating an example of a detailed flow of the slice header encoding process illustrated in FIG. 15.

FIG. 18 is a block diagram illustrating an exemplary configuration of an image decoding device according to an embodiment.

FIG. 19 is a block diagram illustrating an example of a detailed configuration of the syntax decoding section illustrated in FIG. 18.

FIG. 20 is a flowchart illustrating an example of a flow of a decoding process according to an embodiment.

FIG. 21 is a flowchart illustrating an example of a detailed flow of the APS decoding process illustrated in FIG. 20.

FIG. 22 is a flowchart illustrating an example of a detailed flow of the slice header decoding process illustrated in FIG. 20.

FIG. 23 is an explanatory diagram illustrating multiview codec.

FIG. 24 is an explanatory diagram illustrating an image encoding process according to an embodiment applied to multiview codec.

FIG. 25 is an explanatory diagram illustrating an image decoding process according to an embodiment applied to multiview codec.

FIG. 26 is an explanatory diagram illustrating scalable codec.

FIG. 27 is an explanatory diagram illustrating an image encoding process according to an embodiment applied to scalable codec.

FIG. 28 is an explanatory diagram illustrating an image decoding process according to an embodiment applied to scalable codec.

FIG. 29 is a block diagram illustrating a schematic configuration of a television apparatus.

FIG. 30 is a block diagram illustrating a schematic configuration of a mobile phone.

FIG. 31 is a block diagram illustrating a schematic configuration of a recording/reproduction device.

FIG. 32 is a block diagram illustrating a schematic configuration of an image capturing device.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Also, the description will proceed in the following order.

1. Exemplary configuration of image encoding device according to embodiment
1-1. Exemplary overall configuration
1-2. Overview of parameter set structure
1-3. Exemplary configuration of syntax encoding section

2. Process flow during encoding according to embodiment
2-1. Overview of process
2-2. APS encoding process
2-3. Slice header encoding process

3. Exemplary configuration of image decoding device according to embodiment
3-1. Exemplary overall configuration
3-2. Exemplary configuration of syntax decoding section

4. Process flow during decoding according to embodiment
4-1. Overview of process
4-2. APS decoding process
4-3. Slice header decoding process

5. Application to various codecs
5-1. Multiview codec
5-2. Scalable codec

6. Applications

7. Conclusion

### 1. EXEMPLARY CONFIGURATION OF IMAGE ENCODING DEVICE ACCORDING TO EMBODIMENT

[1-1. Overall Configuration]

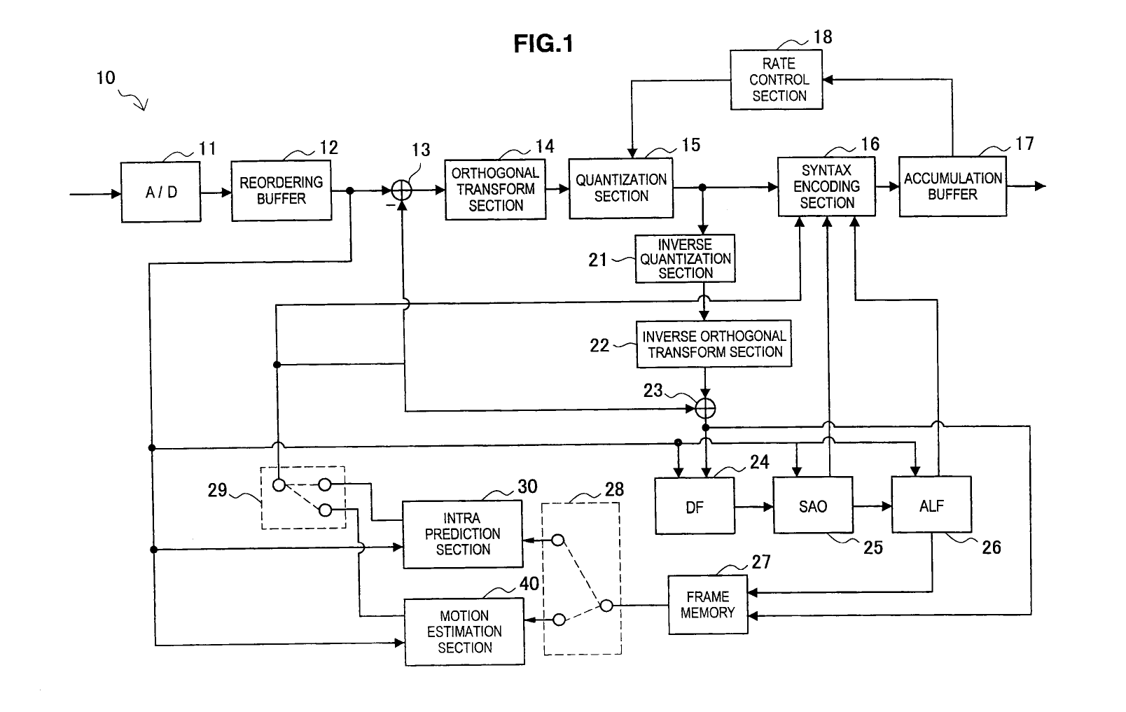

FIG. 1 is a block diagram illustrating an exemplary configuration of an image encoding device 10 according to an embodiment. Referring to FIG. 1, the image encoding device 10 is equipped with an analog to digital (A/D) conversion section 11, a reordering buffer 12, a subtraction section 13, an orthogonal transform section 14, a quantization section 15, a syntax encoding section 16, an accumulation buffer 17, a rate control section 18, an inverse quantization section 21, an inverse orthogonal transform section 22, an addition section 23, a deblocking filter (DF) 24, an adaptive offset section (SAO) 25, an adaptive loop filter (ALF) 26, frame memory 27, selectors 28 and 29, an intra prediction section 30, and a motion estimation section 40.

The A/D conversion section 11 converts an image signal input in an analogue format into image data in a digital format, and outputs a series of digital image data to the reordering buffer 12.

The reordering buffer 12 reorders the images included in the sequence of image data input from the A/D conversion section 11. After reordering the images according to a group of pictures (GOP) structure in accordance with the encoding process, the reordering buffer 12 outputs the reordered image data to the subtraction section 13, the intra prediction section 30, and the motion estimation section 40.

The subtraction section 13 is supplied with image data input from the reordering buffer 12, and predicted image data input from the intra prediction section 30 or the motion estimation section 40 described later. The subtraction section 13 calculates prediction error data, which is the difference between the image data input from the reordering buffer 12 and the predicted image data, and outputs the calculated prediction error data to the orthogonal transform section 14.

The orthogonal transform section 14 performs orthogonal transform on the prediction error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The quantization section 15 is supplied with transform coefficient data input from the orthogonal transform section 14, and a rate control signal from the rate control section 18 described later. The quantization section 15 quantizes the transform coefficient data, and outputs the quantized transform coefficient data (hereinafter referred to as quantized data) to the syntax encoding section 16 and the inverse quantization section 21. The quantization matrix (QM) used in the quantization process by the quantization section 15 (as well as the inverse quantization process by the inverse quantization section 21) may be switched according to the image content. QM-related parameters that define a quantization matrix are inserted into a header area of the encoded stream by the syntax encoding section 16 discussed later. The quantization section 15 may also vary the bit rate of quantized data output to the syntax encoding section 16 by switching a quantization parameter (quantization scale) on the basis of a rate control signal from the rate control section 18.

The syntax encoding section 16 generates an encoded stream by performing a lossless encoding process on the quantized data input from the quantization section 15. The lossless encoding by the syntax encoding section 16 may be variable-length coding or arithmetic coding, for example. In addition, the syntax encoding section 16 sets or acquires various parameters that are referenced during image decoding, and inserts those parameters into the header area of the encoded stream. In H.264/AVC, parameters used for image encoding and decoding are transmitted inside two types of parameters sets called a sequence parameter set (SPS) and a picture parameter set (PPS). In addition to the SPS and the PPS, HEVC introduces an adaptive parameter set (APS) primarily for transmitting parameters that are adaptively set for each picture. An encoded stream generated by the syntax encoding section 16 is mapped to a bitstream in units called network abstraction layer (NAL) units. The SPS, PPS, and APS are mapped to non-VCL NAL units. On the other hand, the quantized data of each slice is mapped to video coding layer (VCL) NAL units. Each slice includes a slice header, and inside the slice header there are referenced parameters for decoding that slice. The syntax encoding section 16 outputs an encoded stream generated in this way to the accumulation buffer 17. A detailed configuration of the syntax encoding section 16 will be further described later.

The accumulation buffer 17 temporarily buffers the encoded stream input from the syntax encoding section 16. The accumulation buffer 17 then outputs the buffered encoded stream to a transmission section not illustrated (such as a communication interface or a connection interface with peripheral equipment, for example), at a rate according to the bandwidth of the transmission channel.

The rate control section 18 monitors the free space in the accumulation buffer 17. Then, the rate control section 18 generates a rate control signal according to the free space in the accumulation buffer 17, and outputs the generated rate control signal to the quantization section 15. For example, when there is not much free space in the accumulation buffer 17, the rate control section 18 generates a rate control signal for lowering the bit rate of the quantized data. Also, when there is sufficient free space in the accumulation buffer 17, for example, the rate control section 18 generates a rate control signal for raising the bit rate of the quantized data.

The inverse quantization section 21 performs an inverse quantization process on the quantized data input from the quantization section 15. The inverse quantization section 21 then outputs the transform coefficient data acquired by the inverse quantization process to the inverse orthogonal transform section 22.

The inverse orthogonal transform unit 22 restores the prediction error data by applying an inverse orthogonal transform to the transform coefficient data input from the inverse quantization section 21. The inverse orthogonal transform section 22 then outputs the restored prediction error data to the addition section 23.

The addition section 23 adds the restored prediction error data input from the inverse orthogonal transform section 22 and the predicted image data input from the intra prediction section 30 or the motion estimation section 40 to thereby generate decoded image data. Then, the addition section 23 outputs the generated decoded image data to the deblocking filter 24 and the frame memory 27.

The deblocking filter 24 applies filtering to reduce blocking artifacts produced at the time of image encoding. The deblocking filter 24 removes blocking artifacts by filtering the decoded image data input from the addition section 23, and outputs the filtered decoded image data to the adaptive offset section 25.

The adaptive offset section 25 improves the image quality of a decoded image by adding an adaptively determined offset value to each pixel value in a post-DF decoded image. In a typical sample adaptive offset (SAO) process, nine types of patterns are usable as offset value-setting patterns (hereinafter referred to as offset patterns): two types of band offsets, six types of edge offsets, and no offset. Such offset patterns and offset values may be switched according to the image content. These SAO-related parameters are inserted into a header area of the encoded stream by the syntax encoding section 16 discussed above. The adaptive offset section 25 outputs decoded image data, having offset pixel values as a result of an adaptive offset process, to the adaptive loop filter 26.

The adaptive loop filter 26 minimizes error between the decoded image and the original image by filtering the post-SAO decoded image. Typically, the adaptive loop filter 26 is realized using a Wiener filter. The filter coefficients of a Wiener filter used in an adaptive loop filter (ALF) process by the adaptive loop filter 26 may be switched according to the image content. ALF-related parameters, including filter coefficients and a flag for switching the filter on/off, are inserted into a header area of the encoded stream by the syntax encoding section 16 discussed above. The adaptive loop filter 26 outputs decoded image data, whose difference with the original image is minimized as a result of the adaptive loop filter process, to the frame memory 27.

The frame memory 27 uses a storage medium to store decoded image data input from the addition section 23, and post-ALF decoded image data input from the adaptive loop filter 26.

The selector 28 retrieves post-ALF decoded image data to be used for inter prediction from the frame memory 27, and supplies the retrieved decoded image data to the motion estimation section 40 as reference image data. In addition, the selector 28 retrieves pre-DF decoded image data to be used for intra prediction from the frame memory 27, and supplies the retrieved decoded image data to the intra prediction section 30 as reference image data.

In inter prediction mode, the selector 29 outputs predicted image data as a result of inter prediction output from the motion estimation section 40 to the subtraction section 13, and also outputs information related to inter prediction to the syntax encoding section 16. In addition, in intra prediction mode, the selector 29 outputs predicted image data as a result of intra prediction output from the intra prediction section 30 to the subtraction section 13, and also outputs information related to intra prediction to the syntax encoding section 16. The selector 29 switches between inter prediction mode and intra prediction mode according to the magnitudes of cost function values output from the intra prediction section 30 and the motion estimation section 40.

The intra prediction section 30 conducts an intra prediction process for each block set within an image, on the basis of image data to be encoded (original image data) that is input from the reordering buffer 12, and decoded image data used as reference image data that is supplied from the frame memory 27. The intra prediction section 30 then outputs information related to intra prediction, including prediction mode information indicating an optimal prediction mode, as well as a cost function value and predicted image data, to the selector 29.

The motion estimation section 40 conducts a motion estimation process for inter prediction (inter-frame prediction) on the basis of original image data input from the reordering buffer 12, and decoded image data supplied via the selector 28. The motion estimation section 40 then outputs information related to inter prediction, including motion vector information and reference image information, as well as a cost function value and predicted image data, to the selector 29.

[1-2. Overview of Parameter Set Structure]

Among the parameters handled by the image encoding device 10 discussed above, ALF-related parameters, SAO-related parameters, and QM-related parameters have values that may be adaptively updated for each picture, and also have the property of a comparatively large data size. Consequently, these parameters are more appropriately stored in the APS rather than being stored in the PPS together with other parameters. However, several techniques are conceivable as techniques for storing these parameters in the APS.

(1) First Technique

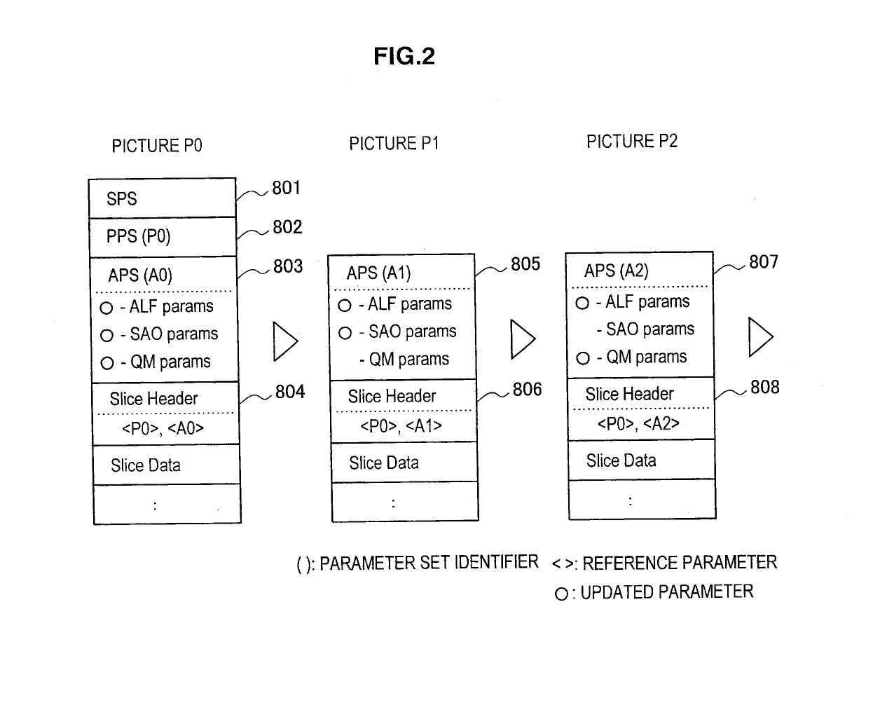

The first technique is a technique that lists all target parameters inside one APS, and references each parameter using an APS ID, an identifier that uniquely identifies that APS. FIG. 2 illustrates an example of an encoded stream structured in accordance with the first technique.

Referring to FIG. 2, an SPS 801, a PPS 802, and an APS 803 are inserted at the start of a picture P0 positioned at the beginning of a sequence. The PPS 802 is identified by the PPS ID “P0”. The APS 803 is identified by the APS ID “A0”. The APS 803 includes ALF-related parameters, SAO-related parameters, and QM-related parameters. A slice header 804 attached to slice data inside the picture P0 includes a reference PPS ID “P0”, and this means that parameters inside the PPS 802 are referenced in order to decode that slice data. Similarly, the slice header 804 includes a reference APS ID “A0”, and this means that parameters inside the APS 803 are referenced in order to decode that slice data.

An APS 805 is inserted into a picture P1 following the picture P0. The APS 805 is identified by the APS ID “A1”. The APS 805 includes ALF-related parameters, SAO-related parameters, and QM-related parameters. The ALF-related parameters and the SAO-related parameters included in the APS 805 have been updated from the APS 803, but the QM-related parameters have not been updated. A slice header 806 attached to slice data inside the picture P1 includes a reference APS ID “A1”, and this means that parameters inside the APS 805 are referenced in order to decode that slice data.

An APS 807 is inserted into a picture P2 following the picture P1. The APS 807 is identified by the APS ID “A2”. The APS 807 includes ALF-related parameters, SAO-related parameters, and QM-related parameters. The ALF-related parameters and the QM-related parameters included in the APS 807 have been updated from the APS 805, but the SAO-related parameters have not been updated. A slice header 808 attached to slice data inside the picture P2 includes a reference APS ID “A2”, and this means that parameters inside the APS 807 are referenced in order to decode that slice data.

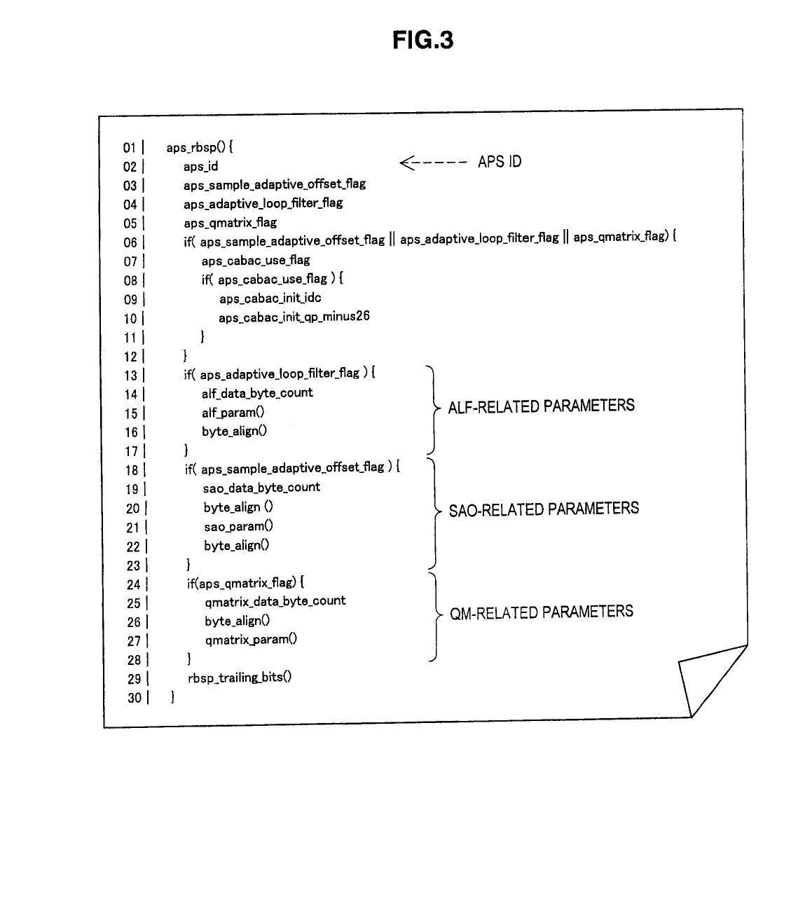

FIG. 3 illustrates an example of APS syntax defined in accordance with the first technique. On line 2 in FIG. 3, an APS ID for uniquely identifying that APS is specified. The ALF-related parameters are specified on line 13 to line 17. The SAO-related parameters are specified on line 18 to line 23. The QM-related parameters are specified on line 24 to line 28. The “aps_qmatrix_flag” on line 24 is a present flag indicating whether QM-related parameters are set inside that APS. In the case where the present flag on line 24 indicates that QM-related parameters are set inside that APS (aps_qmatrix_flag=1), the function qmatrix_param( ) may be used to set quantization matrix parameters inside that APS. Note that since the specific content of the function qmatrix_param( ) is already understood by persons skilled in the art, description thereof will be reduced or omitted herein.

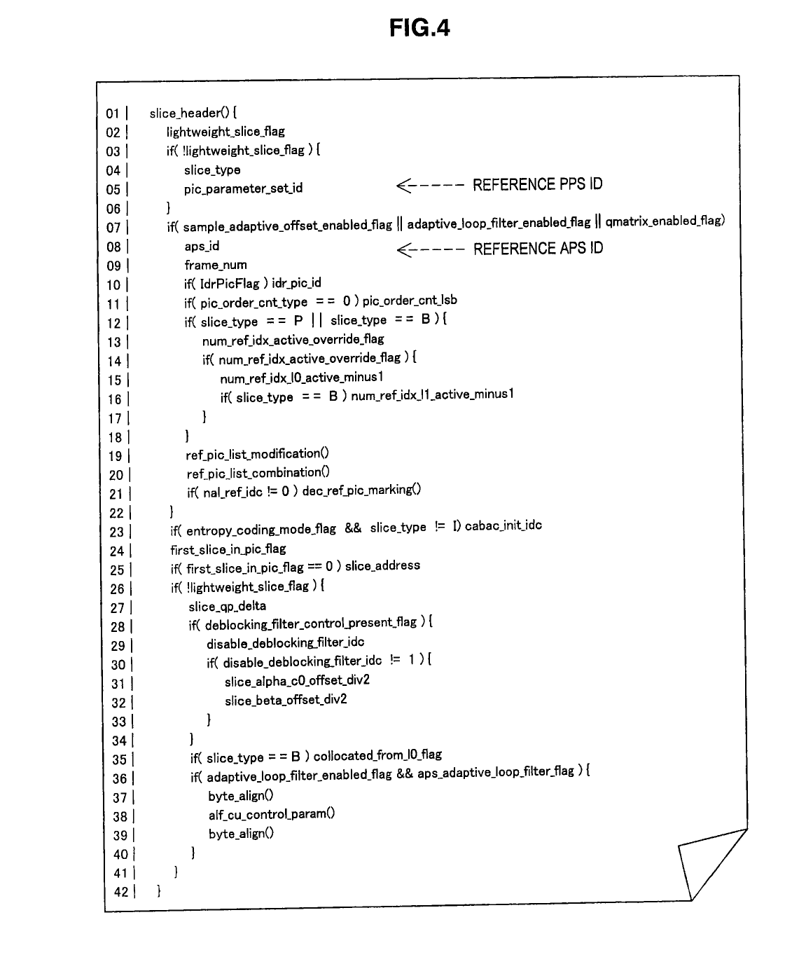

FIG. 4 is an explanatory diagram illustrating an example of slice header syntax defined in accordance with the first technique. On line 5 in FIG. 4, there is specified a reference PPS ID for referencing parameters included in the PPS from among the parameters to be set for that slice. On line 8, there is specified a reference APS ID for referencing parameters included in the APS from among the parameters to be set for that slice.

According to the first technique, it is possible to use a single APS ID to reference all parameters included in an APS, irrespective of the classes of parameters. For this reason, the logic for encoding and decoding parameters is extremely simplified, and device implementation becomes easy. In addition, it becomes possible to use a present flag to partially update only the quantization matrix parameters from among the parameters relating to various coding tools potentially included in the APS, or alternatively, partially not update only the quantization matrix parameters. In other words, since it is possible to include quantization matrix parameters in the APS only when updating the quantization matrix becomes necessary, quantization matrix parameters can be efficiently transmitted inside the APS.

(2) Exemplary Modification of First Technique

A technique in accordance with the exemplary modification described below may also be implemented in order to further reduce the bit rate of quantization matrix parameters inside the APS.

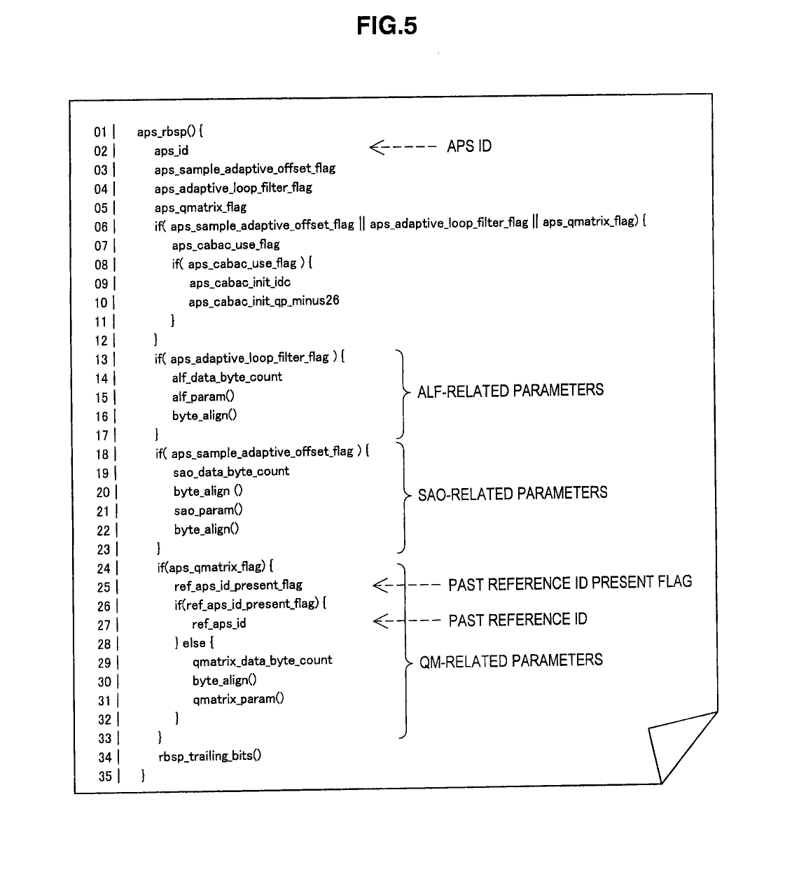

FIG. 5 illustrates an example of APS syntax defined in accordance with an exemplary modification of the first technique. In the syntax illustrated in FIG. 5. the QM-related parameters are specified on line 24 to line 31. The “aps_qmatrix_flag” on line 24 is a present flag indicating whether QM-related parameters are set inside that APS. The “ref_aps_id_present_flag” on line 25 is a past reference ID present flag indicating whether a past reference ID is used as the QM-related parameter in that APS. In the case where the past reference ID present flag indicates that a past reference ID is to be used (ref_aps_id_present_flag=1), a past reference ID “ref_aps_id” is set on line 27. The past reference ID is an identifier for referencing the APS ID of an APS encoded or decoded before the current APS. In the case where a past reference ID is used, quantization matrix parameters are not set inside the reference source (latter) APS. In this case, a quantization matrix set on the basis of the quantization matrix parameters in the reference target APS indicated by the past reference ID may be reused as a quantization matrix corresponding to the reference source APS. Note that a past reference ID referencing the APS ID of a reference source APS (what is called self-reference) may be prohibited. Instead, a default quantization matrix may be set as a quantization matrix corresponding to a self-referencing APS. In the case where a past reference ID is not used (ref_aps_id_present_flag=0), the function “qmatrix_param( )” on line 31 may be used to set quantization matrix parameters inside that APS.

In this way, by using a past reference ID to reuse an already encoded or decoded quantization matrix, repeatedly setting the same quantization matrix parameters inside the APS is avoided. Thus, the rate of quantization matrix parameters inside the APS can be reduced. Note that although FIG. 5 illustrates an example in which the APS ID is used in order to reference a past APS, the means of referencing a past APS is not limited to such an example. For example, another parameter such as the number of APSs between the reference source APS and the reference target APS may also be used in order to reference a past APS. Also, instead of using the past reference ID present flag, the referencing of a past APS and the setting of new quantization matrix parameters may be switched depending on whether or not the past reference ID indicates a given value (minus one, for example.)

(3) Second Technique

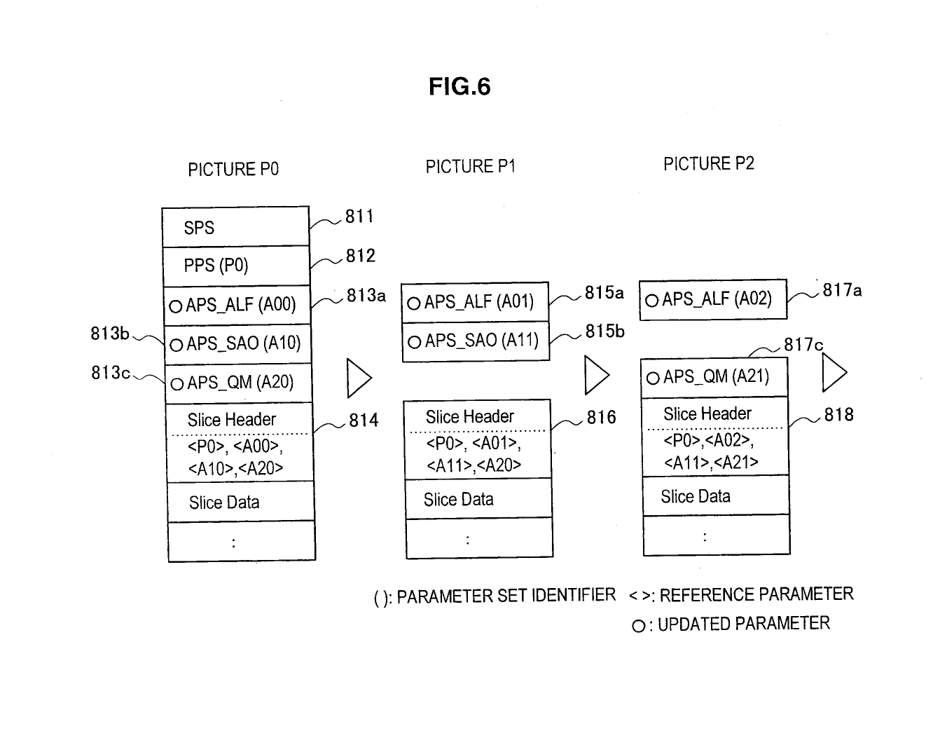

The second technique is a technique that stores parameters in different APSs (different NAL units) for each class of parameter, and references each parameter using an APS ID that uniquely identifies each APS. FIG. 6 illustrates an example of an encoded stream configured in accordance with the second technique.

Referring to FIG. 6, an SPS 811, a PPS 812, an APS 813a, an APS 813b, and an APS 813c are inserted at the start of a picture P0 positioned at the beginning of a sequence. The PPS 812 is identified by the PPS ID “P0”. The APS 813a is an APS for ALF-related parameters, and is identified by the APS ID “A00”. The APS 813b is an APS for SAO-related parameters, and is identified by the APS ID “A10”. The APS 813c is an APS for QM-related parameters, and is identified by the APS ID “A20”. A slice header 814 attached to slice data inside the picture P0 includes a reference PPS ID “P0”, and this means that parameters inside the PPS 812 are referenced in order to decode that slice data. Similarly, the slice header 814 includes a reference APS_ALF ID “A00”, a reference APS_SAO ID “A10”, and a reference APS_QM ID “A20”, and these mean that parameters inside the APSs 813a, 813b, and 813c are referenced in order to decode that slice data.

An APS 815a and an APS 815b are inserted into a picture P1 following the picture P0. The APS 815a is an APS for ALF-related parameters, and is identified by the APS ID “A01”. The APS 815b is an APS for SAO-related parameters, and is identified by the APS ID “A11”. Since the QM-related parameters are not updated from the picture P0, an APS for QM-related parameters is not inserted. A slice header 816 attached to slice data inside the picture P1 includes a reference APS_ALF ID “A01”, a reference APS_SAO ID “A11”, and a reference APS_QM ID “A20”. These mean that parameters inside the APSs 815a, 815b, and 813c are referenced in order to decode that slice data.

An APS 817a and an APS 817c are inserted into a picture P2 following the picture P1. The APS 817a is an APS for ALF-related parameters, and is identified by the APS ID “A02”. The APS 817c is an APS for QM-related parameters, and is identified by the APS ID “A21”. Since the SAO-related parameters are not updated from the picture P1, an APS for SAO-related parameters is not inserted. A slice header 818 attached to slice data inside the picture P2 includes a reference APS_ALF ID “A02”, a reference APS_SAO ID “A11”, and a reference APS_QM ID “A21”. These mean that parameters inside the APSs 817a, 815b, and 817c are referenced in order to decode that slice data.

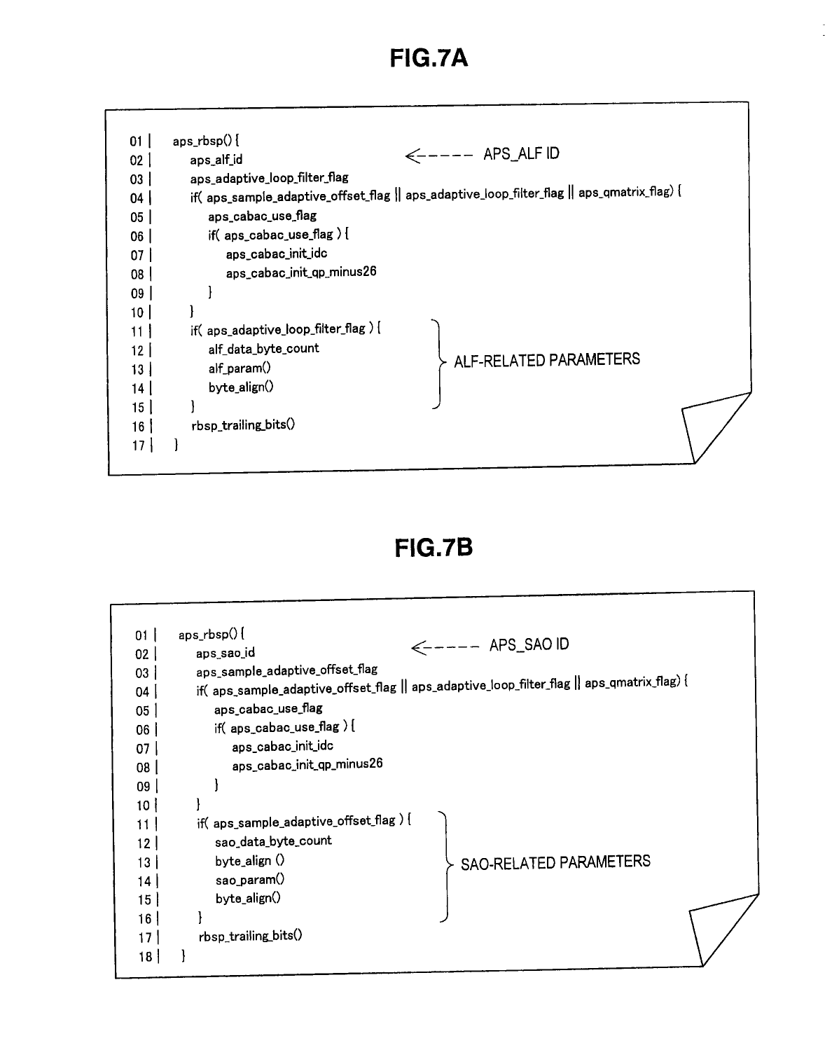

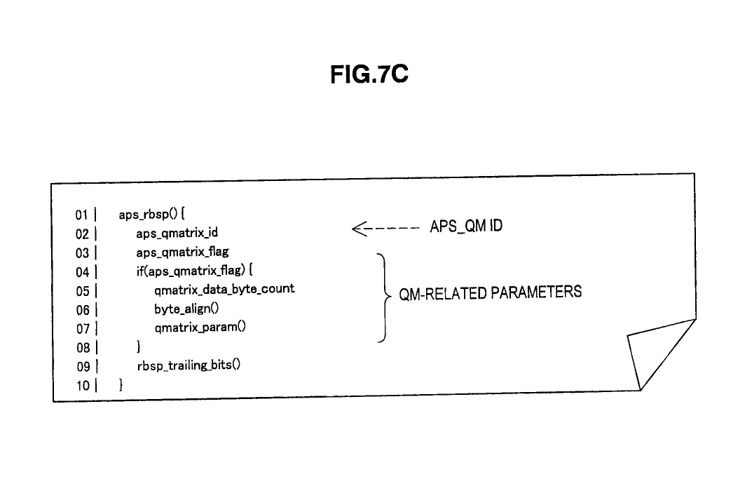

FIG. 7A illustrates an example of ALF APS syntax defined in accordance with the second technique. On line 2 in FIG. 7A, an APS_ALF ID for uniquely identifying that APS is specified. The ALF-related parameters are specified on line 11 to line 15. FIG. 7B illustrates an example of SAO APS syntax defined in accordance with the second technique. On line 2 in FIG. 7B, an APS_SAO ID for uniquely identifying that APS is specified. The SAO-related parameters are specified on line 11 to line 16. FIG. 7C illustrates an example of QM APS syntax defined in accordance with the second technique. On line 2 in FIG. 7C, an APS_QM ID for uniquely identifying that APS is specified. The QM-related parameters are specified on line 4 to line 8.

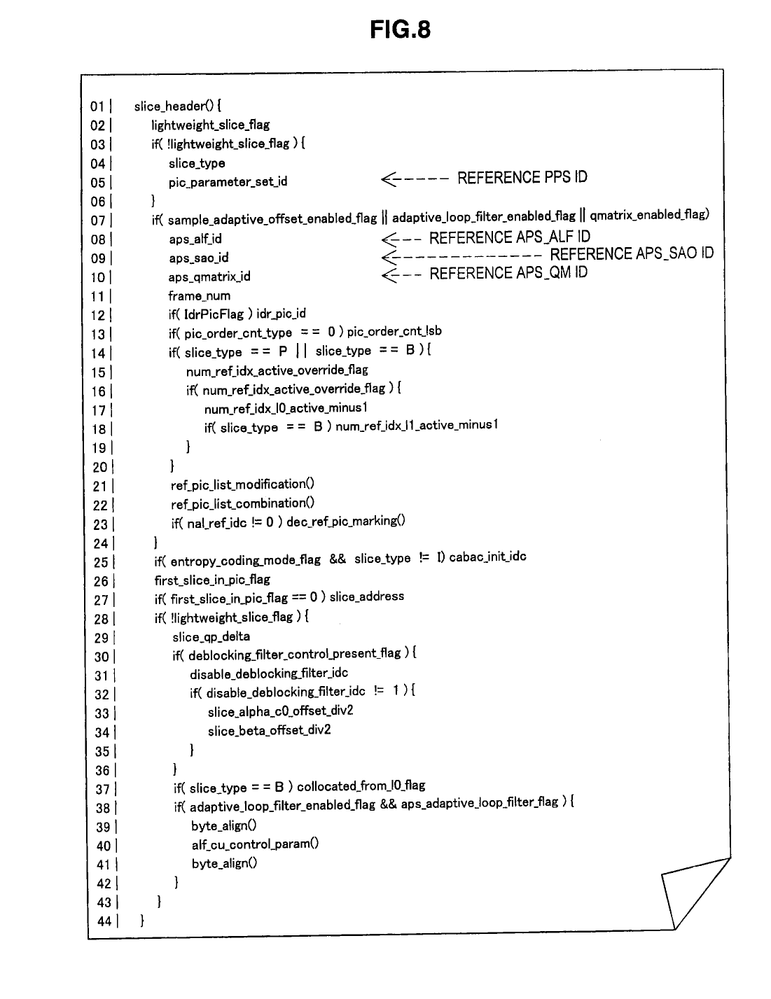

FIG. 8 is an explanatory diagram illustrating an example of slice header syntax defined in accordance with the second technique. On line 5 in FIG. 8, there is specified a reference PPS ID for referencing parameters included in the PPS from among the parameters to be set for that slice. On line 8, there is specified a reference APS_ALF ID for referencing parameters included in the ALF APS from among the parameters to be set for that slice. On line 9, there is specified a reference APS_SAO ID for referencing parameters included in the SAO APS from among the parameters to be set for that slice. On line 10, there is specified a reference APS_QM ID for referencing parameters included in the QM APS from among the parameters to be set for that slice.

According to the second technique, a different APS is used for each class of parameter. Likewise in this case, the transmission of redundant parameters is not conducted for parameters that do not require updating. For this reason, the coding efficiency may be optimized. However, with the second technique, as the classes of parameters to be incorporated into the APS increase, there is an increase in the classes of NAL unit types (nal_unit_type), an identifier for identifying classes of the APS. In the standard specification of HEVC, there are a limited number of NAL unit types (nal_unit_type) reserved for extensions. Consequently, the second technique, which expends many NAL unit types for the APS, may possibly compromise the flexibility of future extensions to the specification.

(4) Third Technique

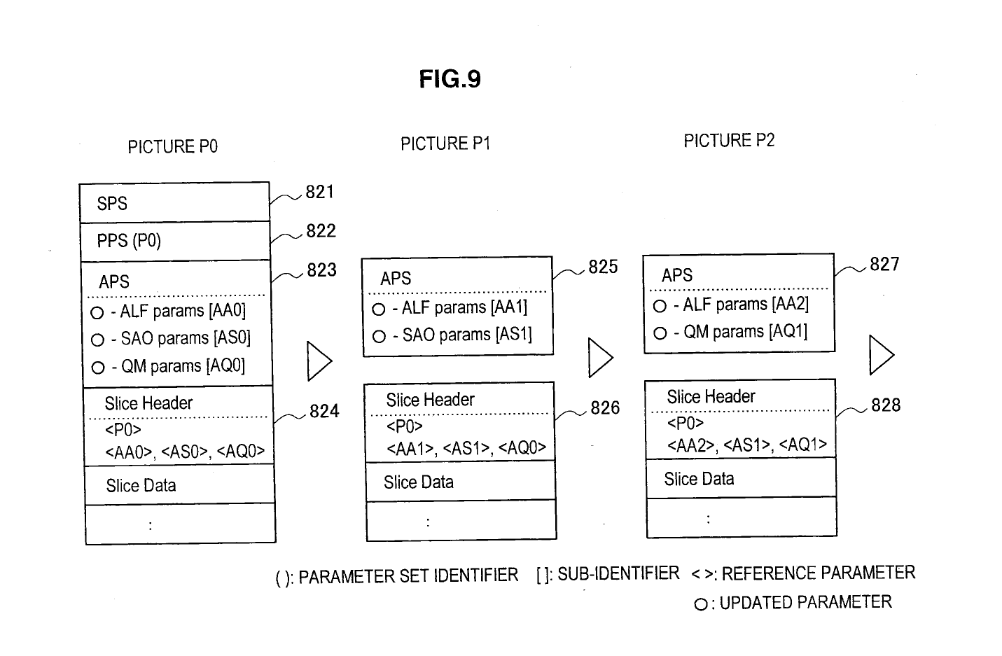

The third technique is a technique that groups parameters to be included in the APS per an identifier defined separately from the APS ID, and includes parameters belonging to one or more groups within a single APS. In this specification, this identifier assigned to each group and defined separately from the APS ID is called the sub-identifier (SUB ID). Also, a group identified by a sub-identifier is called a parameter group. Each parameter is referenced using the sub-identifier in the slice header. FIG. 9 illustrates an example of an encoded stream structured in accordance with the third technique.

Referring to FIG. 9, an SPS 821, a PPS 822, and an APS 823 are inserted at the start of a picture P0 positioned at the beginning of a sequence. The PPS 822 is identified by the PPS ID “P0”. The APS 823 includes ALF-related parameters, SAO-related parameters, and QM-related parameters. The ALF-related parameters belong to one group, and are identified by a SUB_ALF ID “AA0”, a sub-identifier for ALF. The SAO-related parameters belong to one group, and are identified by a SUB_SAO ID “AS0”, a sub-identifier for SAO. The QM-related parameters belong to one group, and are identified by a SUB_QM ID “AQ0”, a sub-identifier for QM. A slice header 824 attached to slice data inside the picture P0 includes a reference SUB_ALF ID “AA0”, a reference SUB_SAO ID “AS0”, and a reference SUB_QM ID “AQ0”. These mean that the ALF-related parameters belonging to the SUB_ALF ID “AA0”, the SAO-related parameters belonging to the SUB_SAO ID “AS0”, and the QM-related parameters belonging to the SUB_QM ID “AQ0” are referenced in order to decode that slice data.

An APS 825 is inserted into a picture P1 following the picture P0. The APS 825 includes ALF-related parameters and SAO-related parameters. The ALF-related parameters are identified by a SUB_ALF ID “AA1”. The SAO-related parameters are identified by a SUB_SAO ID “AS1”. Since the QM-related parameters are not updated from the picture P0, QM-related parameters are not included in the APS 825. A slice header 826 attached to slice data inside the picture P1 includes a reference SUB_ALF ID “AA1”, a reference SUB_SAO ID “AS1”, and a reference SUB_QM ID “AQ0”. These mean that the ALF-related parameters belonging to the SUB_ALF ID “AA1” and the SAO-related parameters belonging to the SUB_SAO ID “AS1” inside the APS 825, as well as the QM-related parameters belonging to the SUB_QM ID “AQ0” inside the APS 823, are referenced in order to decode that slice data.

An APS 827 is inserted into a picture P2 following the picture P1. The APS 827 includes ALF-related parameters and QM-related parameters. The ALF-related parameters are identified by a SUB_ALF ID “AA2”. The QM-related parameters are identified by a SUB_QM ID “AQ1”. Since the SAO-related parameters are not updated from the picture P1, SAO-related parameters are not included in the APS 827. A slice header 828 attached to slice data inside the picture P2 includes a reference SUB_ALF ID “AA2”, a reference SUB_SAO ID “AS1”, and a reference SUB_QM ID “AQ1”. These mean that the ALF-related parameters belonging to the SUB_ALF ID “AA2” and the QM-related parameters belonging to the SUB_QM ID “AQ1” inside the APS 827, as well as the SAO-related parameters belonging to the SUB_SAO ID “AS1” inside the APS 825, are referenced in order to decode that slice data.

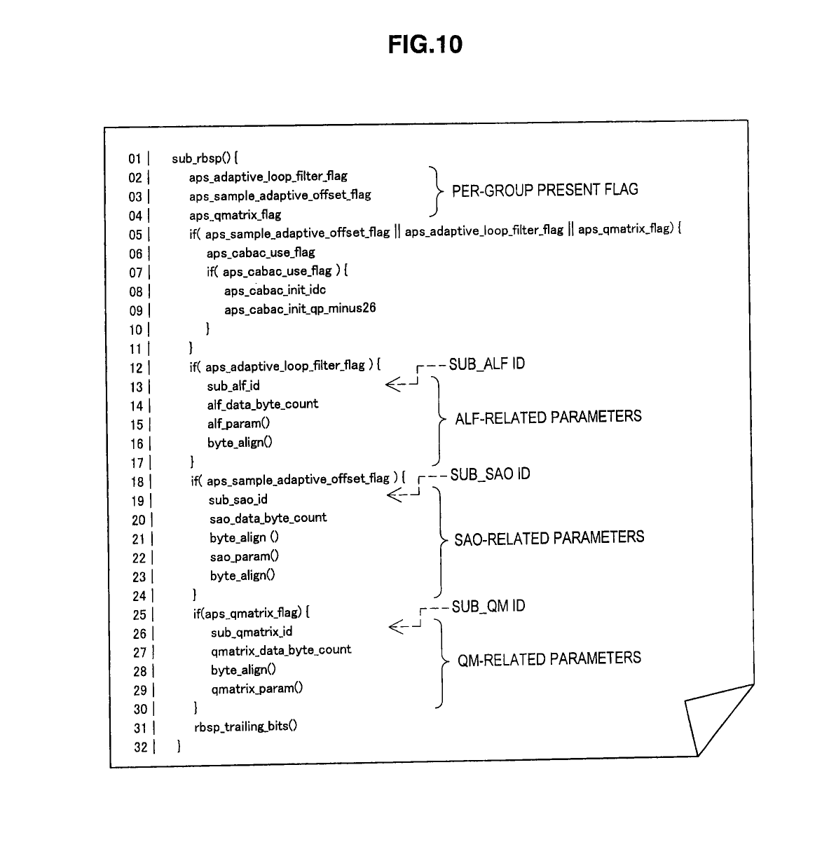

FIG. 10 illustrates an example of APS syntax defined in accordance with the third technique. On line 2 to line 4 of FIG. 3, three group present flags “aps_adaptive_loop_filter_flag”, “aps_sample_adaptive_offset_flag”, and “aps_qmatrix_flag” are specified. The group present flags indicate whether or not parameters belonging to the respective groups are included in that APS. Although the APS ID is omitted from the syntax in the example in FIG. 10, an APS ID for identifying that APS may also be added within the syntax. The ALF-related parameters are specified on line 12 to line 17. The “sub_alf_id” on line 13 is a sub-identifier for ALF. The SAO-related parameters are specified on line 18 to line 24. The “sub_sao_id” on line 19 is a sub-identifier for SAO. The QM-related parameters are specified on line 25 to line 30. The “sub_qmatrix_id” on line 26 is a sub-identifier for QM.

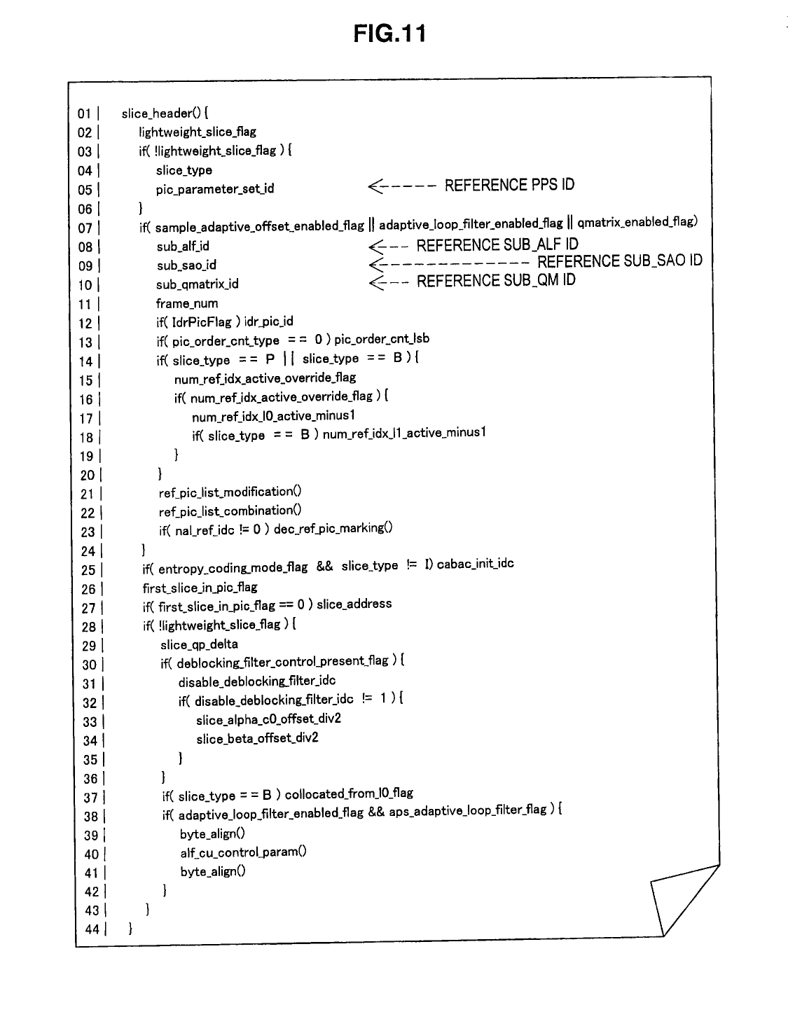

FIG. 11 is an explanatory diagram illustrating an example of slice header syntax defined in accordance with the third technique. On line 5 in FIG. 11, there is specified a reference PPS ID for referencing parameters included in the PPS from among the parameters to be set for that slice. On line 8, there is specified a reference SUB_ALF ID for referencing ALF-related parameters from among the parameters to be set for that slice. On line 9, there is specified a reference SUB_SAO ID for referencing SAO-related parameters from among the parameters to be set for that slice. On line 10, there is specified a reference SUB_QM ID for referencing QM-related parameters from among the parameters to be set for that slice.

According to the third technique, parameters are grouped inside the APS by using sub-identifiers, and the transmission of redundant parameters is not conducted for parameters in parameter groups that do not require updating. For this reason, the coding efficiency may be optimized. Also, since the classes of APSs do not increase even if the classes of parameters increase, large numbers of NAL unit types are not expended as with the second technique discussed earlier. Consequently, the third technique does not compromise the flexibility of future extensions.

(5) Criteria for Grouping Parameters

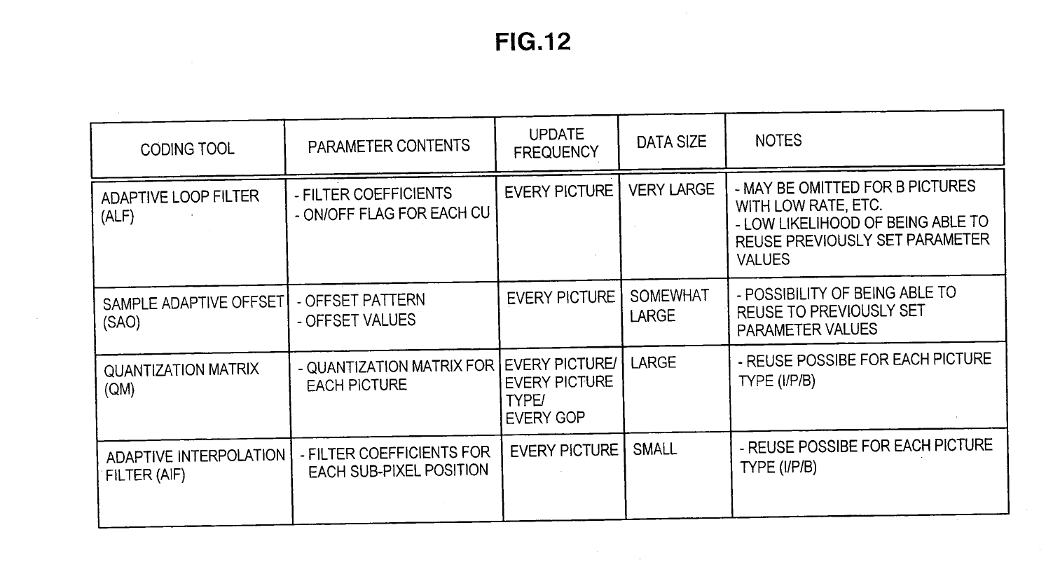

In the examples in FIGS. 9 to 11, parameters included in the APS are grouped according to coding tools relating to ALF, SAO, and QM. However, this is merely one example of grouping parameters. The APS may also include parameters relating to other coding tools. For example, AIF-related parameters such as filter coefficients for an adaptive interpolation filter (AIF) are one example of parameters that may be incorporated into the APS. Hereinafter, various criteria for grouping parameters to be incorporated into the APS will be discussed with reference to FIG. 12.

The table illustrated in FIG. 12 lists “Parameter contents”, “Update frequency”, and “Data size” as features of respective parameters in typical coding tools.

The adaptive loop filter (ALF) is a filter (typically a Wiener filter) that two-dimensionally filters a decoded image with filter coefficients that are adaptively determined so as to minimize the error between the decoded image and the original image. ALF-related parameters include filter coefficients to be applied to each block, and an on/off flag for each coding unit (CU). The data size of ALF filter coefficients is extremely large compared to other classes of parameters. For this reason, ALF-related parameters are ordinarily transmitted for high-rate I pictures, whereas the transmission of ALF-related parameters may be omitted for low-rate β pictures. This is because transmitting ALF-related parameters with a large data size for low-rate pictures is inefficient from a gain perspective. In most cases, the ALF filter coefficients vary for each picture. Since the filter coefficients depend on the image content, the possibility of being able to reuse previously set filter coefficients is low.

The sample adaptive offset (SAO) is a tool that improves the image quality of a decoded image by adding an adaptively determined offset value to each pixel value in a decoded image. SAO-related parameters include offset patterns and offset values. The data size of SAO-related parameters is not as large as ALF-related parameters. SAO-related parameters likewise vary for each picture as a general rule. However, since SAO-related parameters have the property of not changing very much even if the image content changes slightly, there is a possibility of being able to reuse previously set parameter values.

The quantization matrix (QM) is a matrix whose elements are quantization scales used when quantizing transform coefficients transformed from image data by orthogonal transform. QM-related parameters are parameters generated by linearizing and predictively encoding a quantization matrix. The data size of QM-related parameters is larger than SAO-related parameters. The quantization matrix is required for all pictures as a general rule, but does not necessarily require updating for every picture if the image content does not change greatly. For this reason, the quantization matrix may be reused for the same picture types (such as I/P/B pictures), or for each GOP.

The adaptive interpolation filter (AIF) is a tool that adaptively varies the filter coefficients of an interpolation filter used during motion compensation for each sub-pixel position. AIF-related parameters include filter coefficients for respective sub-pixel positions. The data size of AIF-related parameters is small compared to the above three classes of parameters. AIF-related parameters vary for each picture as a general rule. However, since the same picture types tend to have similar interpolation properties, AIF-related parameters may be reused for the same picture types (such as I/P/B pictures).

On the basis of the above parameter qualities, the following three criteria, for example, may be adopted for the purpose of grouping parameters included in the APS:

Criterion A) Grouping according to coding tool

Criterion B) Grouping according to update frequency

Criterion C) Grouping according to likelihood of parameter reuse

Criterion A is a criterion that groups parameters according to their related coding tools. The parameter set structures illustrated by example in FIGS. 9 to 11 are based on the criterion A. Since the properties of parameters are generally determined according to their related coding tools, grouping parameters by coding tool makes it possible to make timely and efficient parameter updates according to the various properties of the parameters.

Criterion B is a criterion that groups parameters according to their update frequency. As illustrated in FIG. 12, ALF-related parameters, SAO-related parameters, and AIF-related parameters all may be updated every picture as a general rule. Thus, these parameters can be grouped into a single parameter group while QM-related parameters are grouped into another parameter group, for example. In this case, there are fewer parameter groups compared to criterion A. As a result, there are also fewer sub-identifiers to specify in the slice header, and the slice header rate can be reduced. Meanwhile, since the update frequencies of parameters belonging to the same parameter group resemble each other, the likelihood of redundantly transmitting non-updated parameters in order to update other parameters is kept low.

Criterion C is a criterion that groups parameters according to the likelihood of parameter reuse. Although ALF-related parameters are unlikely to be reused, SAO-related parameters and AIF-related parameters are somewhat likely to be reused. With QM-related parameters, the parameters are highly likely to be reused over multiple pictures. Consequently, by grouping parameters according to their likelihood of reuse in this way, the redundant transmission of reused parameters inside the APS can be avoided.

(5) Exemplary Modification of Third Technique

With the third technique discussed above, the number of parameter groups into which parameters are grouped inside the APS results in an equal number of reference SUB IDs specified in the slice header, as illustrated by example in FIG. 11. The rate required by the reference SUB IDs is approximately proportional to the product of the number of slice headers and the number of parameter groups. A technique in accordance with the exemplary modification described below may also be implemented in order to further reduce such a rate.

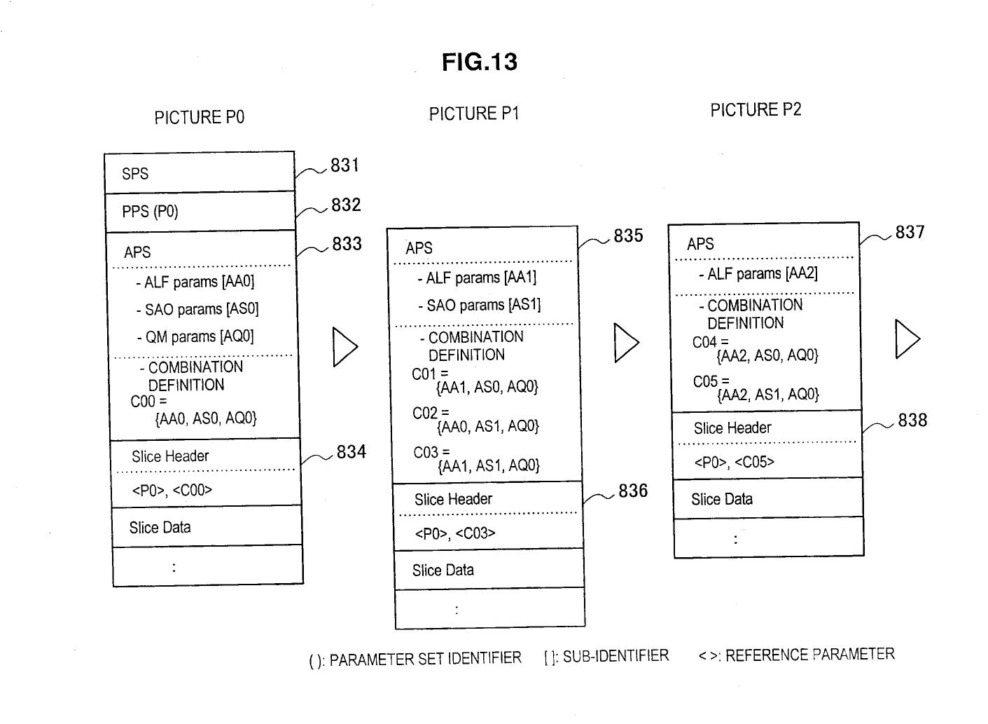

In the exemplary modification of the third technique, a combination ID associated with a combination of sub-identifiers is defined inside the APS or other parameter set. Parameters included inside the APS may then be referenced from a slice header via the combination ID. FIG. 13 illustrates an example of an encoded stream configured according to such an exemplary modification of the third technique.

Referring to FIG. 13, an SPS 831, a PPS 832, and an APS 833 are inserted at the start of a picture P0 positioned at the beginning of a sequence. The PPS 832 is identified by the PPS ID “P0”. The APS 833 includes ALF-related parameters, SAO-related parameters, and QM-related parameters. The ALF-related parameters are identified by a SUB_ALF ID “AA0”. The SAO-related parameters are identified by a SUB_SAO ID “AS0”. The QM-related parameters are identified by a SUB_QM ID “AQ0”. Additionally, the APS 833 includes a combination ID “C00”={AA0, AS0, AQ0} as a definition of a combination. A slice header 834 attached to slice data in the picture P0 includes the combination ID “C00”. This means that the ALF-related parameters belonging to the SUB_ALF ID “AA0”, the SAO-related parameters belonging to the SUB_SAO ID “AS0”, and the QM-related parameters belonging to the SUB_QM ID “AQ0” that are respectively associated with the combination ID “C00” are referenced in order to decode that slice data.

An APS 835 is inserted into a picture P1 following the picture P0. The APS 835 includes ALF-related parameters and SAO-related parameters. The ALF-related parameters are identified by a SUB_ALF ID “AA1”. The SAO-related parameters are identified by a SUB_SAO ID “AS1”. Since the QM-related parameters are not updated from the picture P0, QM-related parameters are not included in the APS 835. Additionally, the APS 835 includes a combination ID “C01”={AA1, AS0, AQ0}, a combination ID “C02”={AA0, AS1, AQ0}, and a combination ID “C03”={AA1, AS1, AQ0} as definitions of combinations. A slice header 836 attached to slice data in the picture P1 includes the combination ID “C03”. This means that the ALF-related parameters belonging to the SUB_ALF ID “AA1”, the SAO-related parameters belonging to the SUB_SAO ID “AS1”, and the QM-related parameters belonging to the SUB_QM ID “AQ0” that are respectively associated with the combination ID “C03” are referenced in order to decode that slice data.

An APS 837 is inserted into a picture P2 following the picture P1. The APS 837 includes ALF-related parameters. The ALF-related parameters are identified by a SUB_ALF ID “AA2”. Since the SAO-related parameters and the QM-related parameters are not updated from the picture P1, SAO-related parameters and QM-related parameters are not included in the APS 837. Additionally, the APS 837 includes a combination ID “C04”={AA2, AS0, AQ0} and a combination ID “C05”={AA2, AS1, AQ0} as definitions of combinations. A slice header 838 attached to slice data in the picture P2 includes the combination ID “C05”. This means that the ALF-related parameters belonging to the SUB_ALF ID “AA2”, the SAO-related parameters belonging to the SUB_SAO ID “AS1”, and the QM-related parameters belonging to the SUB_QM ID “AQ0” that are respectively associated with the combination ID “C05” are referenced in order to decode that slice data.

Note that in this exemplary modification, combination IDs may not be defined for all combinations of sub-identifiers, such that combinations IDs are defined only for the combinations of sub-identifiers actually referenced in a slice header. Also, combinations of sub-identifiers may be defined inside an APS different from the APS where the corresponding parameters are stored.

In this way, by using a combination ID associated with a combination of sub-identifiers to reference parameters inside the APS, the rate required to reference each parameter from the slice headers can be reduced.

[1-3. Exemplary Configuration of Syntax Encoding Section]

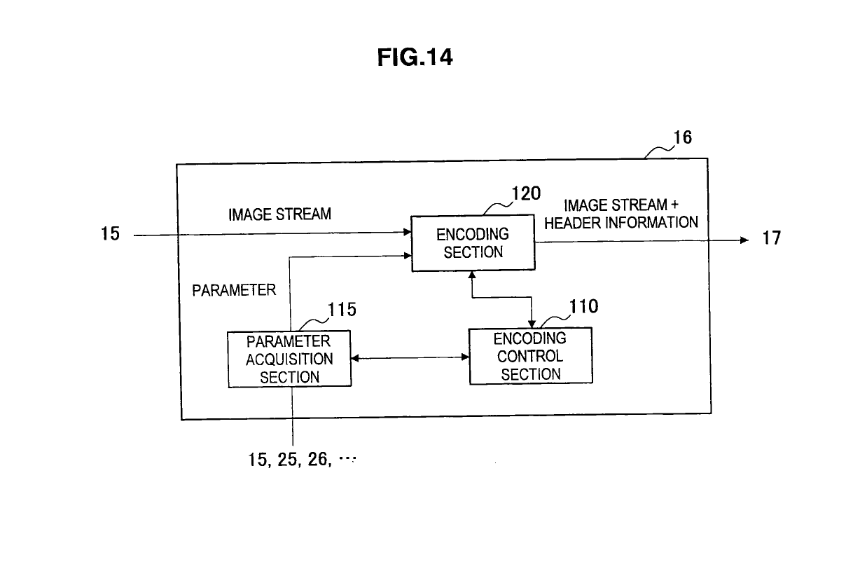

FIG. 14 is a block diagram illustrating an example of a detailed configuration of the syntax encoding section 16 illustrated in FIG. 1. Referring to FIG. 14, the syntax encoding section 16 includes an encoding control section 110, a parameter acquisition section 115, and an encoding section 120.

(1) Encoding Control Section

The encoding control section 110 controls an encoding process conducted by the syntax encoding section 16. For example, the encoding control section 110 recognizes process units such as sequences, pictures, slices, and CUs inside an image stream, and inserts parameters acquired by the parameter acquisition section 115 into a header area, such as the SPS, PPS, APS, or slice header, according to the class of parameter. For example, ALF-related parameters, SAO-related parameters, and QM-related parameters are encoded by the encoding section 120 inside the APS inserted before the slice in which these parameters are referenced. In addition, the encoding control section 110 may also cause the encoding section 120 to encode a combination ID as illustrated by example in FIG. 13 inside one of the parameter sets.

(2) Parameter Acquisition Section

The parameter acquisition section 115 sets or acquires various parameters to be inserted into the header area of the stream. For example, the parameter acquisition section 115 acquires QM-related parameters expressing a quantization matrix from the quantization section 15. Also, the parameter acquisition section 115 acquires SAO-related parameters from the adaptive offset section 25, and ALF-related parameters from the adaptive loop filter 26. The parameter acquisition section 115 then outputs the acquired parameters to the encoding section 120.

(3) Encoding Section

The encoding section 120 encodes quantized data input from the quantization section 15 and parameters input from the parameter acquisition section 115, and generates an encoded stream. In the present embodiment, an encoded stream generated by the encoding section 120 includes three types of parameter sets: the SPS, PPS, and APS. The APS may include ALF-related parameters, SAO-related parameters, and QM-related parameters (as well as other parameters such as AIF-related parameters) that are adaptively set for each picture primarily. The encoding section 120 may encode these parameters in accordance with any of the first to third techniques discussed earlier. For example, the encoding section 120 may group these parameters by individuals SUB IDs, which are sub-identifiers that differ from the APS ID, to form parameter groups, and encode parameters for each parameter group inside the APS. In this case, as illustrated by example in FIG. 10, the encoding section 120 respectively sets, as sub-identifiers, a SUB_ALF ID for ALF-related parameters, a SUB-SAO ID for SAO-related parameters, and a SUB_QM ID for QM-related parameters. The encoding section 120 then encodes these parameters inside a shared APS. In addition, the encoding section 120 may encode a combination ID as illustrated by example in FIG. 13 inside one of the parameter sets.

In addition, a slice header is added to each slice in an encoded stream generated by the encoding section 120. In the slice header, the encoding section 120 encodes reference parameters to be used when referencing parameters to be set for that slice. The reference parameters may be the reference SUB_ALF ID, the reference SUB_SAO ID, and the reference SUB_QM ID illustrated by example in FIG. 11, or the reference combination ID illustrated by example in FIG. 13.

The encoding of parameters by the encoding section 120 may be conducted according to a variable-length coding (VLC) scheme or a context-adaptive binary arithmetic coding (CABAC) scheme, for example. An encoded stream generated by the encoding section 120 is output to the accumulation buffer 17.

### 2. PROCESS FLOW DURING ENCODING ACCORDING TO EMBODIMENT

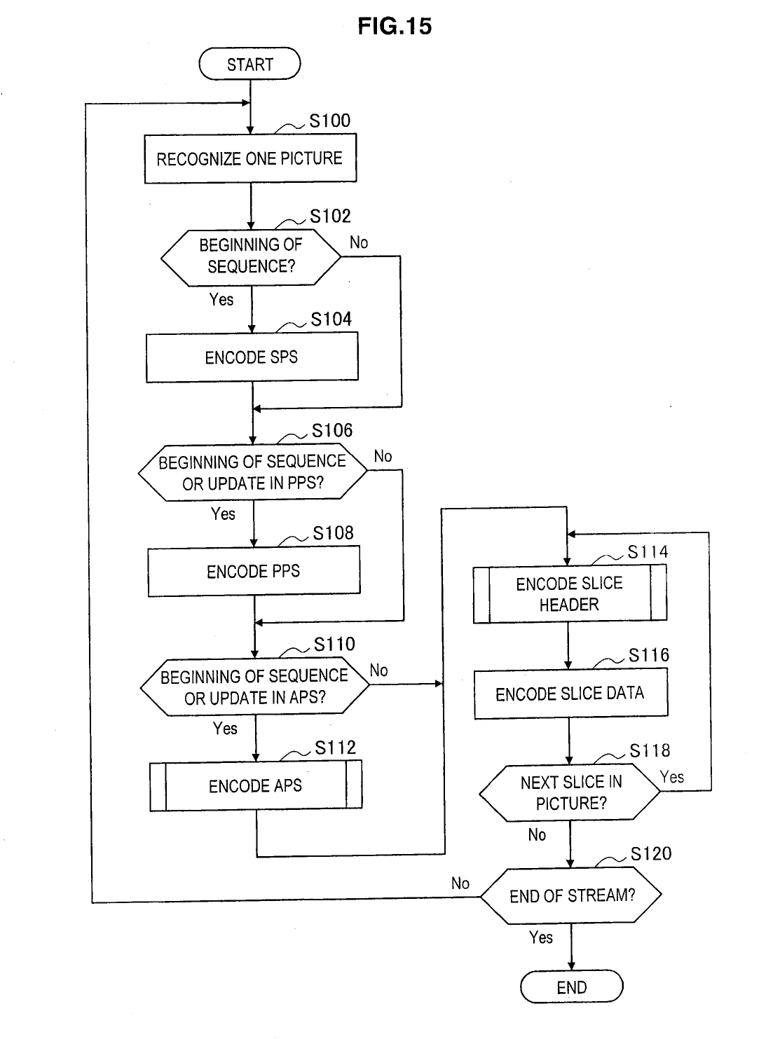

Next, FIGS. 15 to 17 will be used to describe a flow of an encoding process by the syntax encoding section 16 of the image encoding device 10 according to the present embodiment.

[2-1. Overview of Process]

FIG. 15 is a flowchart illustrating an exemplary flow of an encoding process by the syntax encoding section 16 according to the present embodiment.

Referring to FIG. 15, first, the encoding control section 110 recognizes one picture (step S100), and determines whether or not that picture is a picture at the beginning of a sequence (step S102). At this point, in the case in which the picture is a picture at the beginning of a sequence, an SPS is inserted into the encoded stream, and the encoding section 120 encodes parameters inside the SPS (step S104).

Next, the encoding control section 110 determines whether or not the beginning of a sequence or a parameter update inside the PPS has occurred (step S106). At this point, in the case in which the beginning of a sequence or a parameter update inside the PPS has occurred, a PPS is inserted into the encoded stream, and the encoding section 120 encodes parameters inside the PPS (step S108).

Next, the encoding control section 110 determines whether or not the beginning of a sequence or a parameter update inside the APS has occurred (step S110). At this point, in the case in which the beginning of a sequence or a parameter update inside the APS has occurred, an APS is inserted into the encoded stream, and the encoding section 120 encodes parameters inside the APS (step S112).

Next, the encoding section 120 repeats the slice header encoding (step S114) and the slice data encoding (step S116) for all slices in a picture (step S118). Subsequently, when the slice header and slice data encoding finishes for all slices in the picture, the process proceeds to step S120. Then, in the case in which a subsequent picture exists, the process returns to step S100 (step S120). On the other hand, in the case in which a subsequent picture does not exist, the encoding process illustrated in FIG. 15 ends.

[2-2. APS Encoding Process]

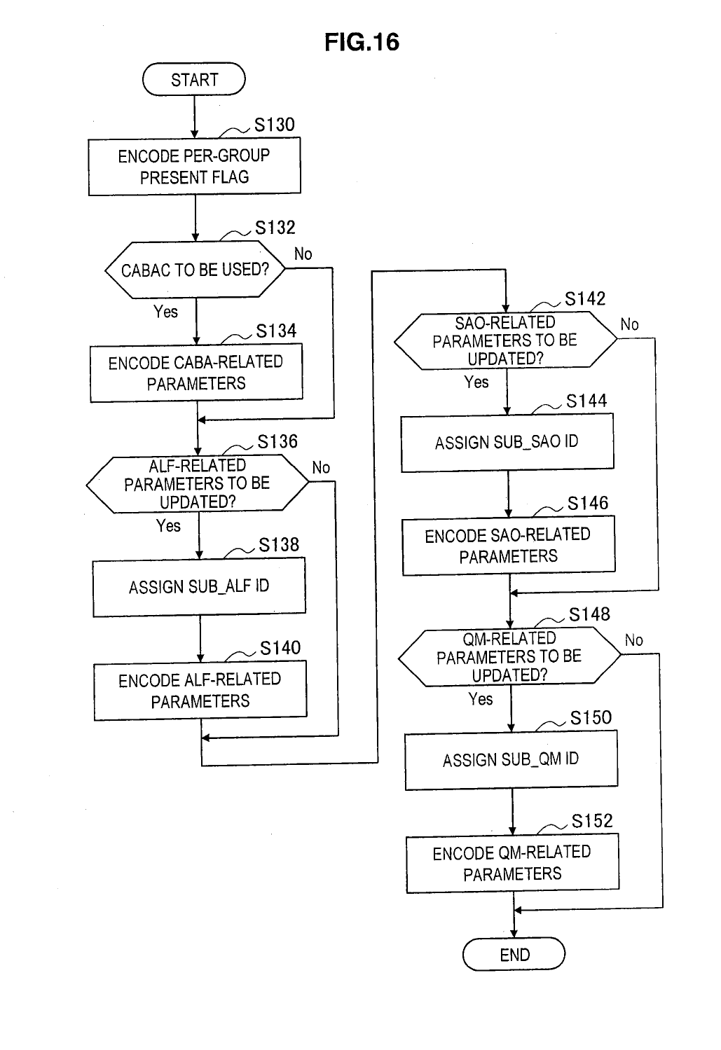

FIG. 16 is a flowchart illustrating an example of a detailed flow of an APS encoding process corresponding to step S112 of FIG. 15. Note that for the sake of the clarity of the description herein, only the primary processing steps relating to the grouping of parameters are illustrated.

Referring to FIG. 16, first, the encoding section 120 encodes per-group present flags inside the APS (step S130). The per-group present flags correspond to “aps_adaptive_loop_filter_flag”, “aps_sample_adaptive_offset_flag”, and “aps_qmatrix_flag” illustrated in FIG. 3, for example, and may be encoded for each group into which parameters are grouped.

Next, the encoding control section 110 determines whether or not to use a CABAC scheme to encode parameters (step S132). Subsequently, in the case in which a CABAC scheme is used, the encoding section 120 encodes CABAC-related parameters (step S134).

Next, the encoding control section 110 determines whether or not ALF-related parameters acquired by the parameter acquisition section 115 are to be updated (step S136). Subsequently, in the case in which the ALF-related parameters are to be updated, the encoding section 120 assigns a new SUB_ALF ID to the ALF-related parameters (step S138), and encodes the ALF-related parameters (step S140).

Next, the encoding control section 110 determines whether or not SAO-related parameters acquired by the parameter acquisition section 115 are to be updated (step S142). Subsequently, in the case in which the SAO-related parameters are to be updated, the encoding section 120 assigns a new SUB_SAO ID to the SAO-related parameters (step S144), and encodes the SAO-related parameters (step S146).

Next, the encoding control section 110 determines whether or not QM-related parameters acquired by the parameter acquisition section 115 are to be updated (step S148). Subsequently, in the case in which the QM-related parameters are to be updated, the encoding section 120 assigns a new SUB_QM ID to the QM-related parameters (step S150), and encodes the QM-related parameters (step S152).

Although not illustrated in FIG. 16, the encoding section 120 may additionally encode, inside the APS, parameters for a combination definition related to a combination of sub-identifiers and a combination ID.

[2-3. Slice Header Encoding Process]

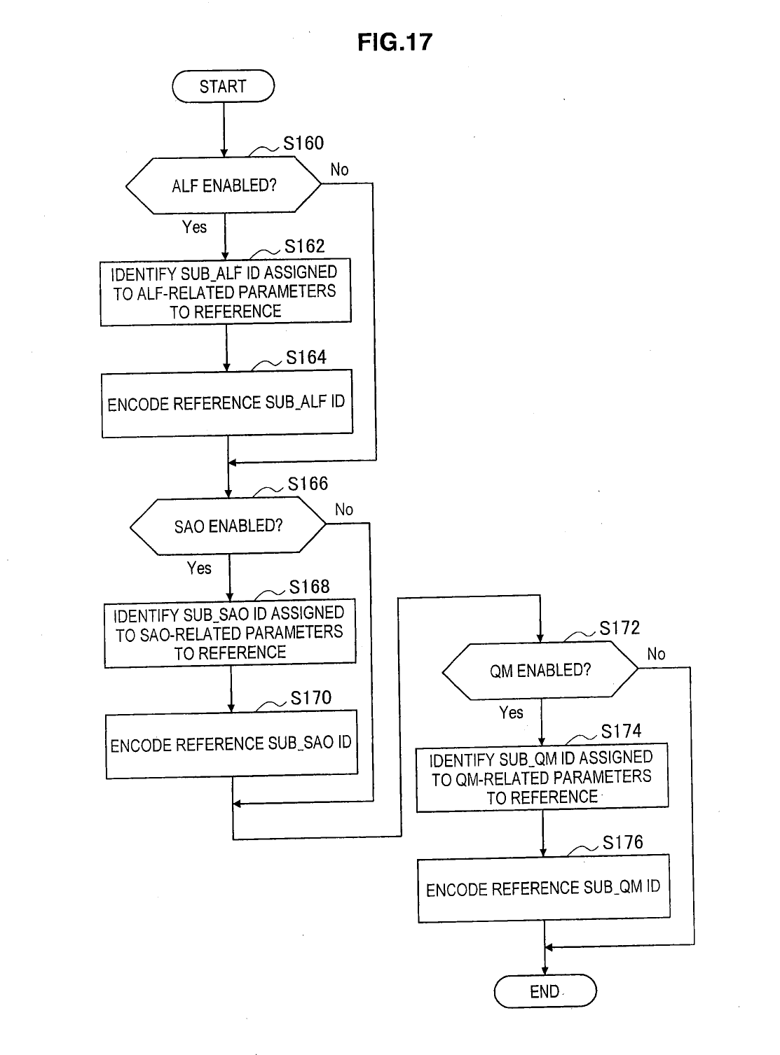

FIG. 17 is a flowchart illustrating an example of a detailed flow of a slice header encoding process corresponding to step S114 of FIG. 15. Note that for the sake of the clarity of the description herein, only the primary processing steps relating to the referencing of grouped parameters are illustrated.

Referring to FIG. 17, first, the encoding control section 110 determines whether or not ALF is enabled as a coding tool (step S160). The question of whether or not a coding tool is enabled may be determined from the value of an enable flag specified inside the SPS for each coding tool (such as “adaptive_loop_filter_enabled_flag” for ALF), for example. In the case in which ALF is enabled, the encoding section 120 identifies the SUB_ALF ID assigned to the ALF-related parameters to be referenced for that slice (step S162). Subsequently, the encoding section 120 encodes the identified SUB_ALF ID as a reference SUB_ALF ID inside the slice header (step S164).

Next, the encoding control section 110 determines whether or not SAO is enabled as a coding tool (step S166). In the case in which SAO is enabled, the encoding section 120 identifies the SUB_SAO ID assigned to the SAO-related parameters to be referenced (step S168). Subsequently, the encoding section 120 encodes the identified SUB_SAO ID as a reference SUB_SAO ID inside the slice header (step S170).

Next, the encoding control section 110 determines whether or not quantization matrix designation is enabled as a coding tool (step S172). In the case in which quantization matrix designation is enabled, the encoding section 120 identifies the SUB_QM ID assigned to the QM-related parameters to be referenced (step S174). Subsequently, the encoding section 120 encodes the identified SUB_QM ID as a reference SUB_QM ID inside the slice header (step S176).

### 3. EXEMPLARY CONFIGURATION OF IMAGE DECODING DEVICE ACCORDING TO EMBODIMENT

This section describes an example of a configuration of an image decoding device 60 that decodes an image from an encoded stream encoded by the image encoding device 10 discussed above.

[3-1. Exemplary Overall Configuration]

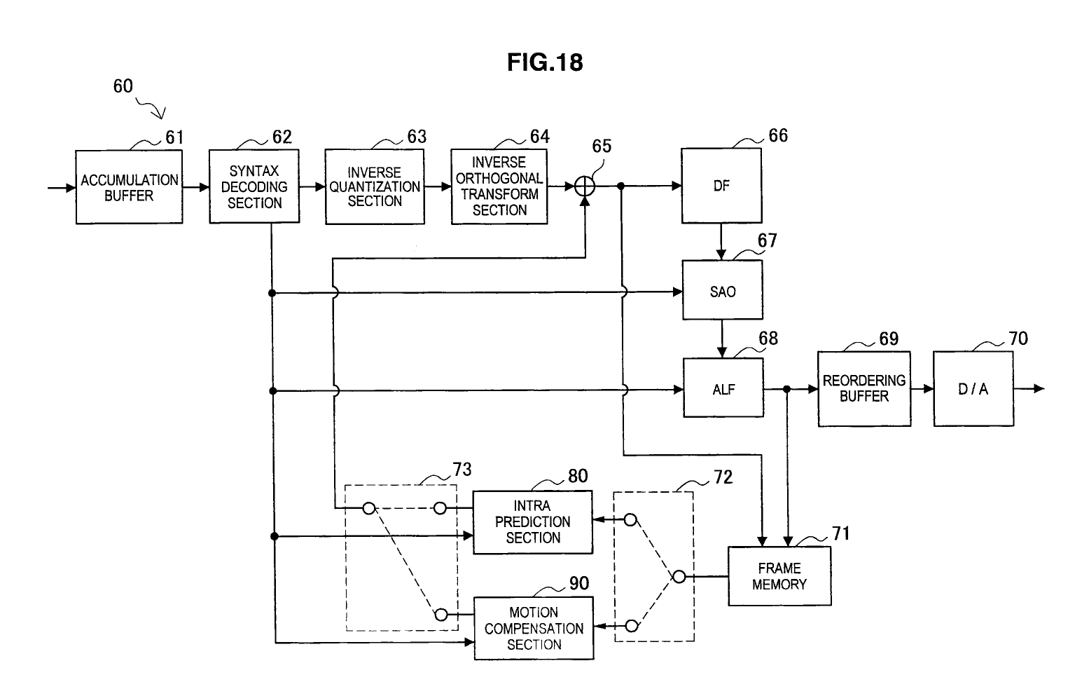

FIG. 18 is a block diagram illustrating an exemplary configuration of an image decoding device 60 according to the present embodiment. Referring to FIG. 18, the image decoding device 60 is equipped with an accumulation buffer 61, a syntax decoding section 62, an inverse quantization section 63, an inverse orthogonal transform section 64, an addition section 65, a deblocking filter (DF) 66, an adaptive offset section (SAO) 67, an adaptive loop filter (ALF) 68, a reordering buffer 69, a digital-to-analog (D/A) conversion section 70, frame memory 71, selectors 72 and 73, an intra prediction section 80, and a motion compensation section 90.

The accumulation buffer 61 temporarily buffers an encoded stream input via a transmission channel.

The syntax decoding section 62 decodes an encoded stream input from the accumulation buffer 61, according to the coding scheme used at the time of encoding. Quantized data included in the encoded stream is decoded by the syntax decoding section 62, and output to the inverse quantization section 63. Also, the syntax decoding section 62 decodes various parameters multiplexed into the header area of the encoded stream. The parameters decoded at this point may include the ALF-related parameters, SAO-related parameters, and QM-related parameters discussed earlier, for example. Parameters decoded by the syntax decoding section 62 are referenced at the time of decoding each slice in an image. A detailed configuration of the syntax decoding section 62 will be further described later.

The inverse quantization section 63 inversely quantizes decoded quantized data from the syntax decoding section 62. In the present embodiment, an inverse quantization process by the inverse quantization section 63 is conducted using QM-related parameters decoded by the syntax decoding section 62. For example, the inverse quantization section 63 inversely quantizes transform coefficients included in quantized data at a quantization step indicated by the elements of a quantization matrix reconstructed from QM-related parameters, and outputs inversely quantized transform coefficient data to the inverse orthogonal transform section 64.

The inverse orthogonal transform section 64 generates prediction error data by performing inverse orthogonal transformation on transform coefficient data input from the inverse quantization section 63 according to the orthogonal transformation scheme used at the time of encoding. Then, the inverse orthogonal transform section 64 outputs the generated prediction error data to the addition section 65.

The addition section 65 adds the prediction error data input from the inverse orthogonal transform section 64 and predicted image data input from the selector 73 to thereby generate decoded image data. Then, the addition section 65 outputs the generated decoded image data to the deblocking filter 66 and the frame memory 71.

The deblocking filter 66 removes blocking artifacts by filtering the decoded image data input from the addition section 65, and outputs the filtered decoded image data to the adaptive offset section 67.

The adaptive offset section 67 improves the image quality of a decoded image by adding an adaptively determined offset value to each pixel value in a post-DF decoded image. In the present embodiment, an adaptive offset process by the adaptive offset section 67 is conducted using SAO-related parameters decoded by the syntax decoding section 62. The adaptive offset section 67 offsets each pixel value according to an offset pattern indicated by the SAO-related parameters, for example. The adaptive offset section 67 outputs decoded image data, having offset pixel values as a result of an adaptive offset process, to the adaptive loop filter 68.

The adaptive loop filter 68 minimizes error between the decoded image and the original image by filtering the post-SAO decoded image. In the present embodiment, an adaptive loop filter process by the adaptive loop filter 68 is conducted using ALF-related parameters decoded by the syntax decoding section 62. The adaptive loop filter 68 applies a Wiener filter having filter coefficients indicated by the ALF-related parameters to each block of a decoded image, for example. The adaptive loop filter 68 outputs decoded image data, which has been filtered as a result of the adaptive loop filter process, to the reordering buffer 69 and the frame memory 71.

The reordering buffer 69 generates a chronological series of image data by reordering images input from the adaptive loop filter 68. The reordering buffer 69 then outputs the generated image data to the D/A conversion section 70.

The D/A conversion section 70 converts digital-format image data input from the reordering buffer 69 into an analog-format image signal. Subsequently, the D/A conversion section 70 causes an image to be displayed by outputting the analog image signal to a display (not illustrated) connected to the image decoding device 60, for example.

The frame memory 71 uses a storage medium to store pre-DF decoded image data input from the addition section 65, and post-ALF decoded image data input from the adaptive loop filter 68.

The selector 72 switches the output destination of image data from the frame memory 71 between the intra prediction section 80 and the motion compensation section 90 for each block in an image, according to mode information acquired by the syntax decoding section 62. For example, in the case in which an intra prediction mode is designated, the selector 72 outputs pre-DF decoded image data supplied from the frame memory 71 to the intra prediction section 80 as reference image data. Also, in the case in which an inter prediction mode is designated, the selector 72 outputs post-ALF decoded image data supplied from the frame memory 71 to the motion compensation section 90 as reference image data.

The selector 73 switches the output source of predicted image data to be supplied to the addition section 65 between the intra prediction section 80 and the motion compensation section 90, according to mode information acquired by the syntax decoding section 62. For example, in the case in which an intra prediction mode is designated, the selector 73 supplies predicted image data output from the intra prediction section 80 to the addition section 65. Also, in the case in which an inter prediction mode is designated, the selector 73 supplies predicted image data output from the motion compensation section 90 to the addition section 65.

The intra prediction section 80 conducts an intra prediction process on the basis of information related to intra prediction input from the syntax decoding section 62 and reference image data from the frame memory 71, and generates predicted image data. The intra prediction section 80 then outputs the generated predicted image data to the selector 73.

The motion compensation section 90 conducts a motion compensation process on the basis of information related to inter prediction input from the syntax decoding section 62 and reference image data from the frame memory 71, and generates predicted image data. The motion compensation section 90 then outputs predicted image data generated as a result of the motion compensation process to the selector 73.

[3-2. Exemplary Configuration of Syntax Decoding Section]

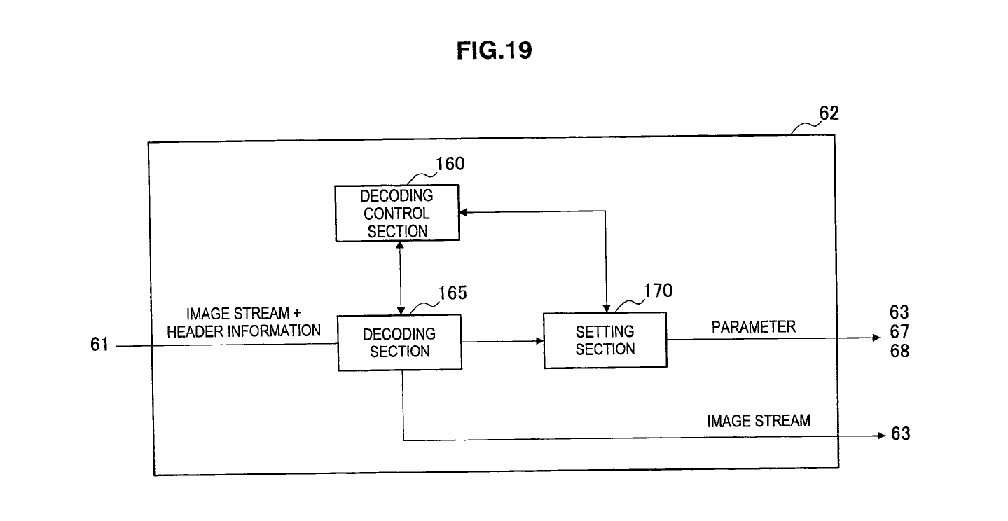

FIG. 19 is a block diagram illustrating an example of a detailed configuration of the syntax decoding section 62 illustrated in FIG. 18. Referring to FIG. 19, the syntax decoding section 62 includes a decoding control section 160, a decoding section 165, and a setting section 170.

(1) Decoding Control Section

The decoding control section 160 controls a decoding process conducted by the syntax decoding section 62. For example, the decoding control section 160 recognizes the SPS, PPS, APS, and slices included in an encoded stream on the basis of the NAL unit type of each NAL unit. Subsequently, the decoding control section 160 causes the decoding section 165 to decode parameters included in the SPS, PPS, and APS, as well as parameters included in the slice header of each slice. In addition, the decoding control section 160 causes the decoding section 165 to decode the slice data of each slice.

(2) Decoding Section

The decoding section 165, under control by the decoding control section 160, decodes parameters and data included in an encoded stream. For example, the decoding section 165 decodes parameter sets such as the SPS, PPS, and APS. The decoding section 165 may decode these parameters in accordance with any of the first to third techniques discussed earlier. For example, the APS may include parameters grouped per a SUB ID, which is a sub-identifier defined separately from the APS ID. To give one example, the parameters included in the APS may include one or more of ALF-related parameters, SAO-related parameters, QM-related parameters, and AIF-related parameters. These parameters are grouped inside the APS according to any of the criterion A, the criterion B, and the criterion C discussed earlier, or another criterion. The decoding section 165 outputs these decoded parameters to the setting section 170 in association with a sub-identifier. Also, in the case in which a combination ID associated with a combination of multiple sub-identifiers is encoded inside the APS or another parameter set, the decoding section 165 decodes that combination ID, and outputs the decoded combination ID to the setting section 170.

In addition, the decoding section 165 decodes the slice header. The slice header includes reference parameters used in order to reference parameters inside an already decoded APS. A reference parameter may be a reference SUB ID designating a sub-identifier (SUB ID) used in order to group parameters inside the APS, for example. Otherwise, a reference parameter may be a reference combination ID designating a combination ID associated with a combination of multiple sub-identifiers. Upon decoding these reference parameters from the slice header, the decoding section 165 outputs the decoded reference parameters to the setting section 170.

Furthermore, the decoding section 165 decodes the quantized data of each slice from the slice data, and outputs the decoded quantized data to the inverse quantization section 63.

(3) Setting Section

The setting section 170 sets parameters decoded by the decoding section 165 in each slice in an image. In the present embodiment, the parameters set by the setting section 170 may include one or more of ALF-related parameters, SAO-related parameters, QM-related parameters, and AIF-related parameters. In the case in which a reference parameter decoded from an individual slice header is a reference SUB ID, for example, the setting section 170 may use the SUB ID matching that reference SUB ID to set parameters to be referenced in that slice. Also, in the case in which a reference parameter decoded from an individual slice header is a reference combination ID, the setting section 170 may use the SUB IDs associated with that reference combination ID to set parameters to be referenced in that slice. For example, ALF-related parameters set in respective slices by the setting section 170 are used during an adaptive loop filter process at the adaptive loop filter 68. SAO-related parameters set in respective slices by the setting section 170 are used during an adaptive offset process at the adaptive offset section 67. QM-related parameters set in respective slices by the setting section 170 are used during an inverse quantization process at the inverse quantization section 63.

### 4. PROCESS FLOW DURING DECODING ACCORDING TO EMBODIMENT

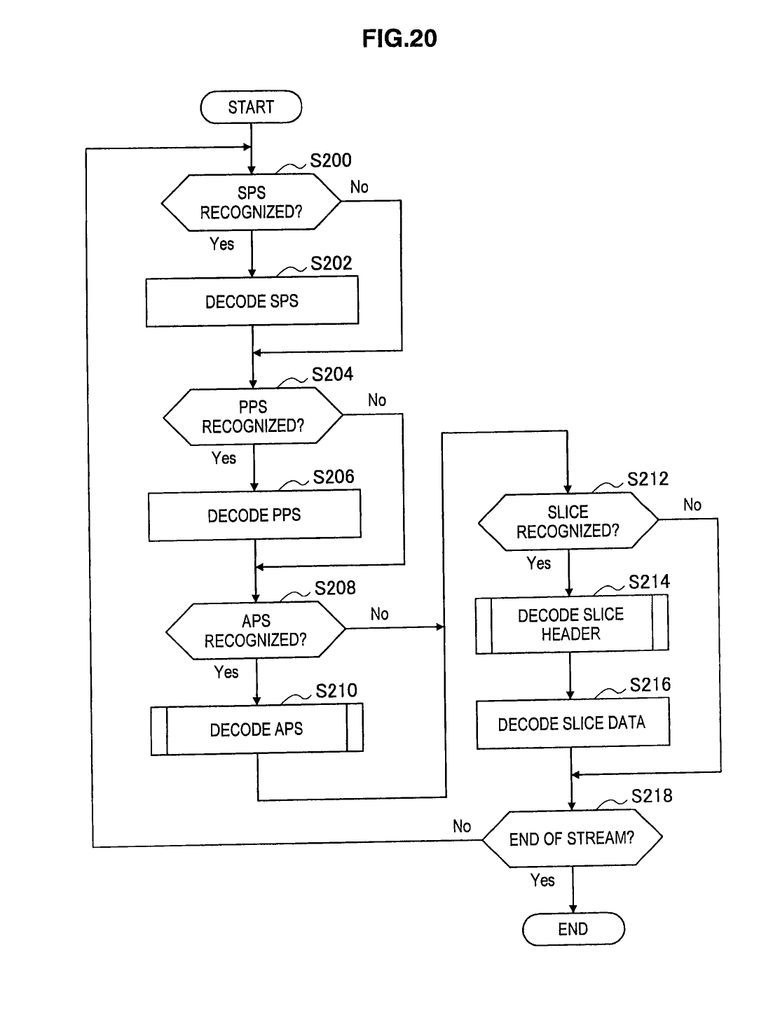

Next, FIGS. 20 to 22 will be used to describe a flow of a decoding process by the syntax decoding section 62 of the image decoding device 60 according to the present embodiment.

[4-1. Overview of Process]

FIG. 20 is a flowchart illustrating an exemplary flow of a decoding process by the syntax decoding section 62 according to the present embodiment.

In the example of FIG. 20, if the decoding control section 160 recognizes an SPS inside an encoded stream (step S200), the decoding section 165 decodes parameters included in the recognized SPS (step S202). Also, if the decoding control section 160 recognizes a PPS (step S204), the decoding section 165 decodes parameters included in the recognized PPS (step S206). Also, if the decoding control section 160 recognizes an APS (step S208), the decoding section 165 decodes parameters included in the recognized APS (step S210). Also, if the decoding control section 160 recognizes a slice (step S212), the decoding section 165 decodes parameters included in the slice header of the recognized slice (step S214), and additionally decodes the slice data of that slice (step S216).

The decoding control section 160 monitors the end of the encoded stream, and repeats such a decoding process until the encoded stream ends (step S218). In the case in which a subsequent picture exists, the process returns to step S200. In the case of detecting the end of the encoded stream, the decoding process illustrated in FIG. 20 ends.

[4-2. APS Decoding Process]

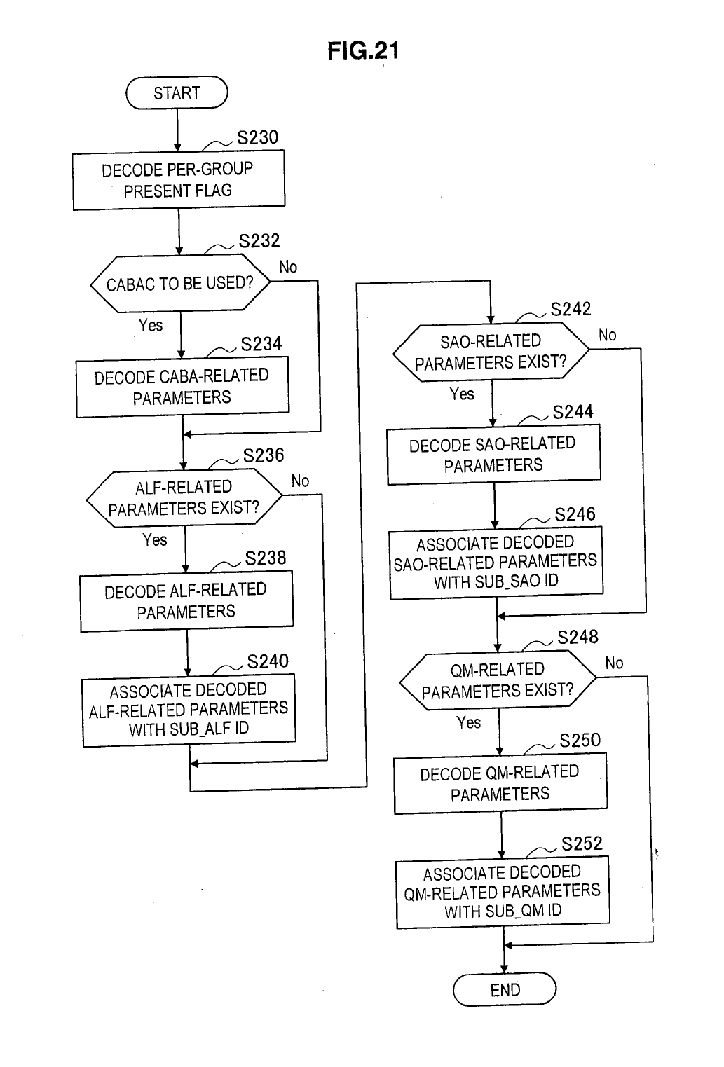

FIG. 21 is a flowchart illustrating an example of a detailed flow of an APS decoding process corresponding to step S210 of FIG. 20. Note that for the sake of the clarity of the description herein, only the primary processing steps relating to the grouping of parameters are illustrated.

Referring to FIG. 21, first, the decoding section 165 decodes per-group present flags inside the APS (step S230). The per-group present flags correspond to “aps_adaptive_loop_filter_flag”, “aps_sample_adaptive_offset_flag”, and “aps_qmatrix_flag” discussed earlier, for example, and may be decoded for each group into which parameters are grouped.

Next, the decoding control section 160 determines whether or not to use a CABAC scheme to decode parameters (step S232). Subsequently, in the case in which a CABAC scheme is used, the decoding section 165 decodes CABAC-related parameters (step S234).

Next, the decoding control section 160 determines whether or not ALF-related parameters are present inside the APS, on the basis of the value of a per-group present flag (step S236). At this point, in the case in which ALF-related parameters exist, the decoding section 165 decodes the ALF-related parameters (step S238), and associates the decoded ALF-related parameters with a SUB_ALF ID (step S240).

Next, the decoding control section 160 determines whether or not SAO-related parameters are present inside the APS, on the basis of the value of a per-group present flag (step S242). At this point, in the case in which SAO-related parameters exist, the decoding section 165 decodes the SAO-related parameters (step S244), and associates the decoded SAO-related parameters with a SUB_SAO ID (step S246).

Next, the decoding control section 160 determines whether or not QM-related parameters are present inside the APS, on the basis of the value of a per-group present flag (step S248). At this point, in the case in which QM-related parameters exist, the decoding section 165 decodes the QM-related parameters (step S250), and associates the decoded QM-related parameters with a SUB_QM ID (step S252).

Although not illustrated in FIG. 21, in the case in which a combination ID associated with a combination of multiple sub-identifiers is encoded inside the APS, the decoding section 165 may additionally decode that combination ID.

[4-3. Slice Header Decoding Process]

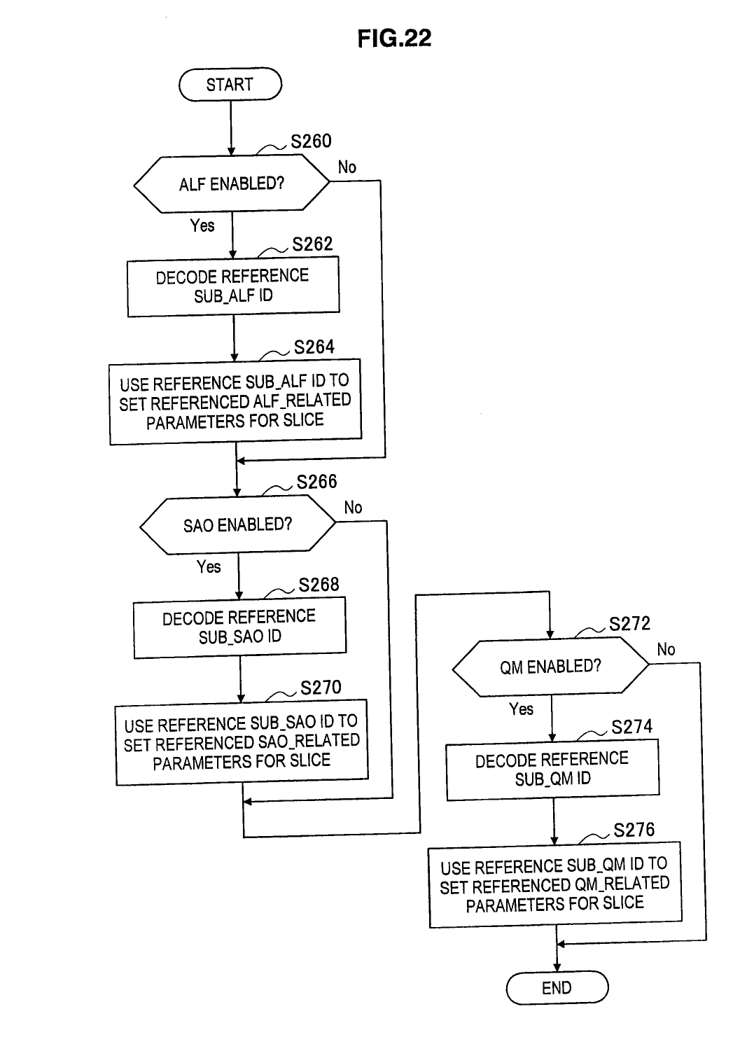

FIG. 22 is a flowchart illustrating an example of a detailed flow of a slice header decoding process corresponding to step S214 of FIG. 20. Note that for the sake of the clarity of the description herein, only the primary processing steps relating to the referencing of grouped parameters are illustrated.

Referring to FIG. 22, first, the decoding control section 160 determines whether or not ALF is enabled as a coding tool (step S260). The question of whether or not a coding tool is enabled may be determined from the value of the enable flag discussed earlier that is specified inside the SPS for each coding tool, for example. In the case in which ALF is enabled, the decoding section 165 decodes from the slice header a reference SUB_ALF ID indicating a sub-identifier given to ALF-related parameters to reference (step S262). Subsequently, the setting section 170 sets, for that slice, the ALF-related parameters associated with the SUB_ALF ED matching the decoded reference SUB_ALF ID (step S264).

Next, the decoding control section 160 determines whether or not SAO is enabled as a coding tool (step S266). In the case in which SAO is enabled, the decoding section 165 decodes from the slice header a reference SUB_SAO ID indicating a sub-identifier given to SAO-related parameters to reference (step S268). Subsequently, the setting section 170 sets, for that slice, the SAO-related parameters associated with the SUB_SAO ID matching the decoded reference SUB_SAO ID (step S270).

Next, the decoding control section 160 determines whether or not quantization matrix designation is enabled as a coding tool (step S272). In the case in which quantization matrix designation is enabled, the decoding section 165 decodes from the slice header a reference SUB_QM ID indicating a sub-identifier given to QM-related parameters to reference (step S274). Subsequently, the setting section 170 sets, for that slice, the QM-related parameters associated with the SUB_QM ID matching the decoded reference SUB_QM ID (step S276).

### 5. APPLICATION TO VARIOUS CODECS

The technology according to the disclosure is applicable to various codecs related to image encoding and decoding. The following describes examples of applying the technology according to the disclosure to multiview codec and scalable codec.

[5-1. Multiview Codec]

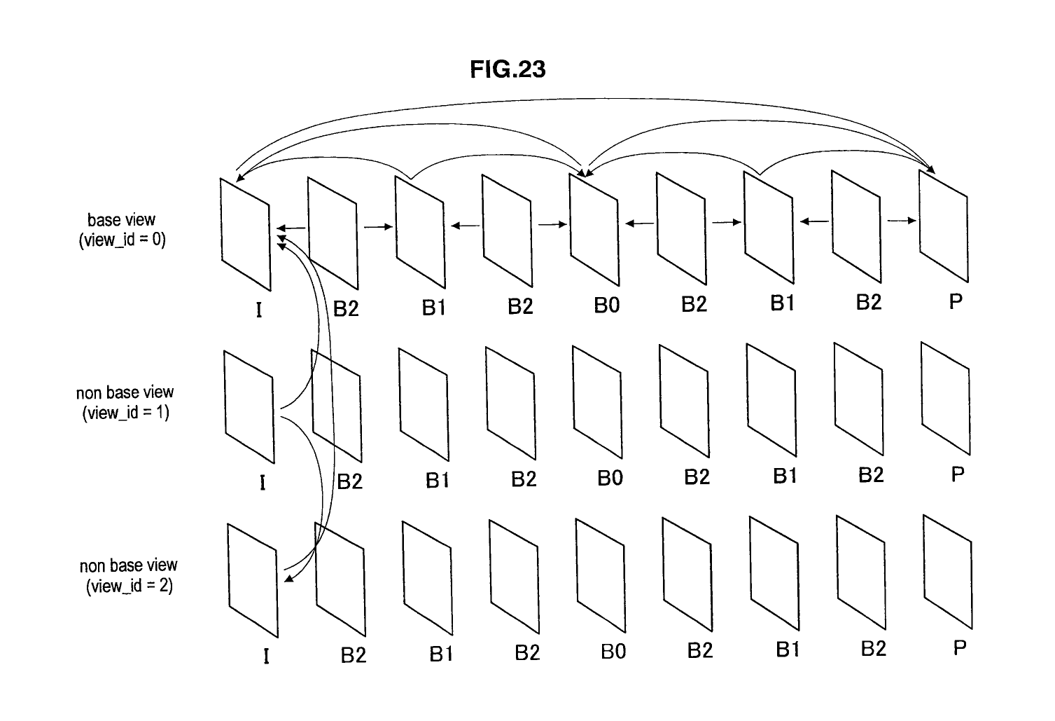

The multiview codec is an image encoding scheme that encodes and decodes multiple-perspective video. FIG. 23 is an explanatory diagram illustrating the multiview codec. FIG. 23 illustrates sequences of frames for three views captured at three observing points. Each view is provided with a view ID (view_id). One of the views is specified as a base view. Views other than the base view are referred to as non-base views. The example in FIG. 23 represents a base view with view ID “0” and two non-base views with view ID “1” or “2.” Encoding multiview image data may compress the data size of the encoded stream as a whole by encoding frames of the non-base view based on encoding information about frames of the base view.

In an encoding process according to the multiview codec described above, a sub-identifier that differs from the APS ID, and a parameter group identified by that sub-identifier, are inserted inside the APS of an encoded stream. In a decoding process according to the multiview codec, the sub-identifier is acquired from the APS of the encoded stream, and parameters inside the above parameter group are referenced using the acquired sub-identifier. Control parameters used for each view may also be set for each view. Also, control parameters set in the base view may be reused for non-base views. Also, a flag indicating whether or not to reuse control parameters across views may be additionally specified.

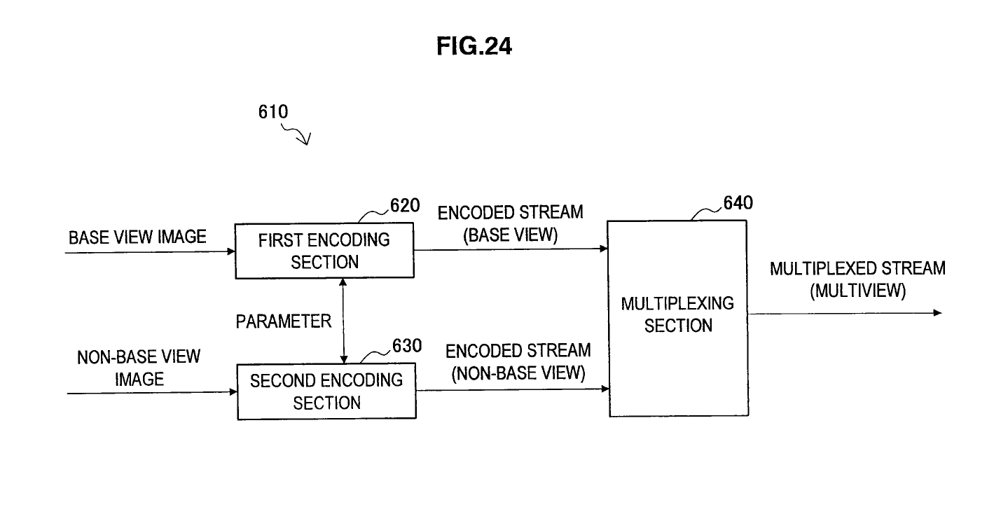

FIG. 24 is an explanatory diagram illustrating the image encoding process applied to the multiview codec described above. FIG. 24 shows a configuration of a multiview encoding device 610 as an example. The multiview encoding device 610 includes a first encoding section 620, a second encoding section 630, and a multiplexing section 640.

The first encoding section 620 encodes a base view image and generates an encoded stream for the base view. The second encoding section 630 encodes a non-base view image and generates an encoded stream for the non-base view. The multiplexing section 640 multiplexes an encoded stream for the base view generated from the first encoding section 620 and one or more encoded streams for the non-base view generated from the second encoding section 630 to generate a multiplexed stream for multiview.

The first encoding section 620 and the second encoding section 630 exemplified in FIG. 24 have a similar configuration to the image encoding device 10 according to an embodiment discussed earlier. For this reason, parameters may be grouped into parameter groups inside the APS of the encoded stream for each view.

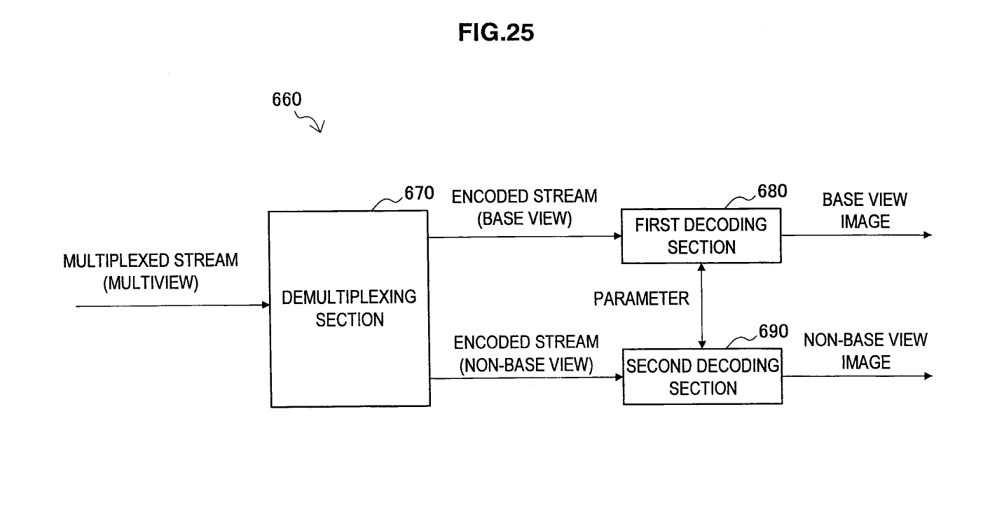

FIG. 25 is an explanatory diagram illustrating an image decoding process applied to the multiview codec described above. FIG. 25 shows a configuration of a multiview decoding device 660 as an example. The multiview decoding device 660 includes a demultiplexing section 670, a first decoding section 680, and a second decoding section 690.

The demultiplexing section 670 demultiplexes a multiplexed stream for multiview into an encoded stream for the base view and an encoded stream for one or more non-base views. The first decoding section 680 decodes a base view image from an encoded stream for the base view. The second decoding section 690 decodes a non-base view image from an encoded stream for the non-base view.

The first decoding section 680 and the second decoding section 690 exemplified in FIG. 25 have a similar configuration to the image decoding device 60 according to an embodiment discussed earlier. For this reason, parameters inside the APS of the encoded stream for each view may be accessed in units of parameter groups, and an image for each view may be decoded.

[5-2. Scalable Codec]

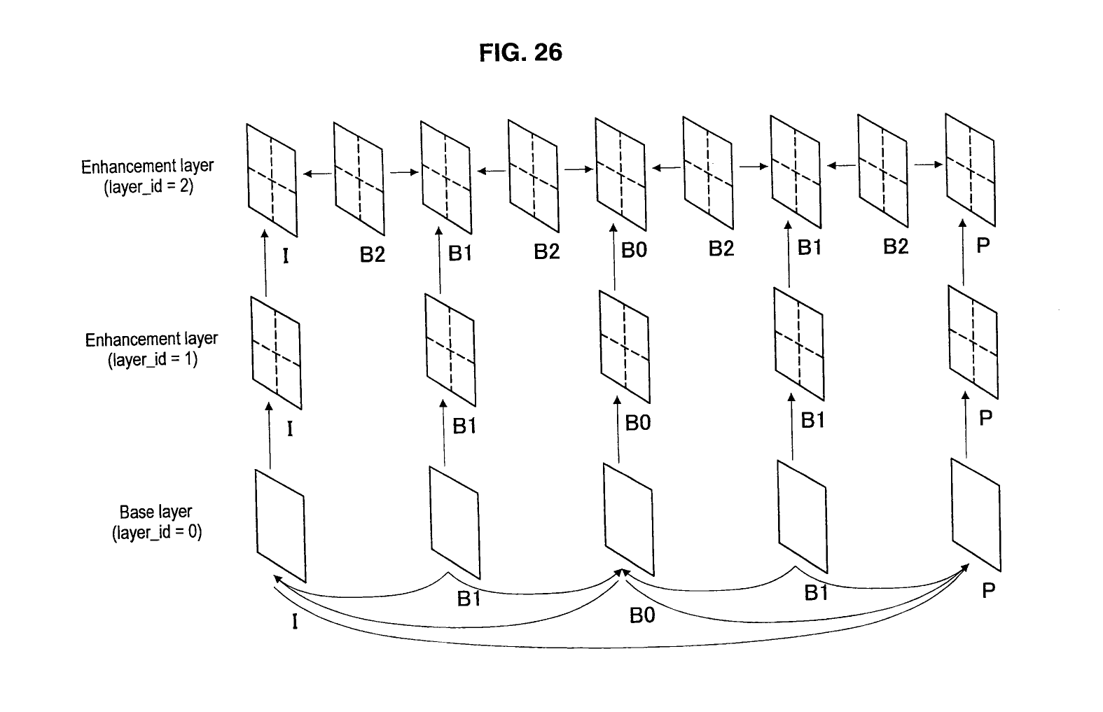

The scalable codec is an image encoding scheme to provide hierarchical encoding. FIG. 26 is an explanatory diagram illustrating the scalable codec. FIG. 26 illustrates frame sequences for three layers of different space resolutions, time resolutions, or image qualities. Each layer is provided with a layer ID (layer_id). These layers include a base layer having the lowest resolution (or image quality). Layers other than the base layer are referred to as enhancement layers. The example in FIG. 26 represents a base layer with layer ID “0” and two enhancement layers with layer ID “1” or “2.” Encoding multi-layer image data may compress the data size of the encoded stream as a whole by encoding frames of the enhancement layer based on encoding information about frames of the base layer.

In an encoding process according to the scalable codec described above, a sub-identifier that differs from the APS ID, and a parameter group identified by that sub-identifier, are inserted inside the APS of an encoded stream. In a decoding process according to the scalable codec, the sub-identifier is acquired from the APS of the encoded stream, and parameters inside the above parameter group are referenced using the acquired sub-identifier. Control parameters used for each layer may also be set for each layer. Also, control parameters set in the base layer may be reused for enhancement layers. Also, a flag indicating whether or not to reuse control parameters across layers may be additionally specified.

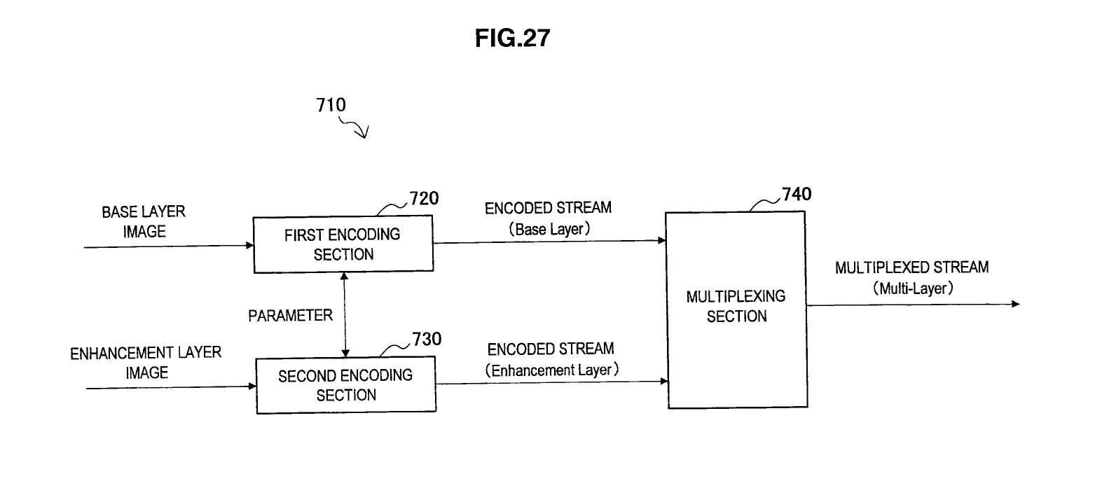

FIG. 27 is an explanatory diagram illustrating the image encoding process applied to the scalable codec described above. FIG. 27 shows a configuration of a scalable encoding device 710 as an example. The scalable encoding device 710 includes a first encoding section 720, a second encoding section 730, and a multiplexing section 740.

The first encoding section 720 encodes a base layer image and generates an encoded stream for the base layer. The second encoding section 730 encodes an enhancement layer image and generates an encoded stream for the enhancement layer. The multiplexing section 740 multiplexes an encoded stream for the base layer generated from the first encoding section 720 and one or more encoded streams for the enhancement layer generated from the second encoding section 730 to generate a multiplexed stream for multi-layer.

The first encoding section 720 and the second encoding section 730 exemplified in FIG. 27 have a similar configuration to the image encoding device 10 according to an embodiment discussed earlier. For this reason, parameters may be grouped into parameter groups inside the APS of the encoded stream for each layer.

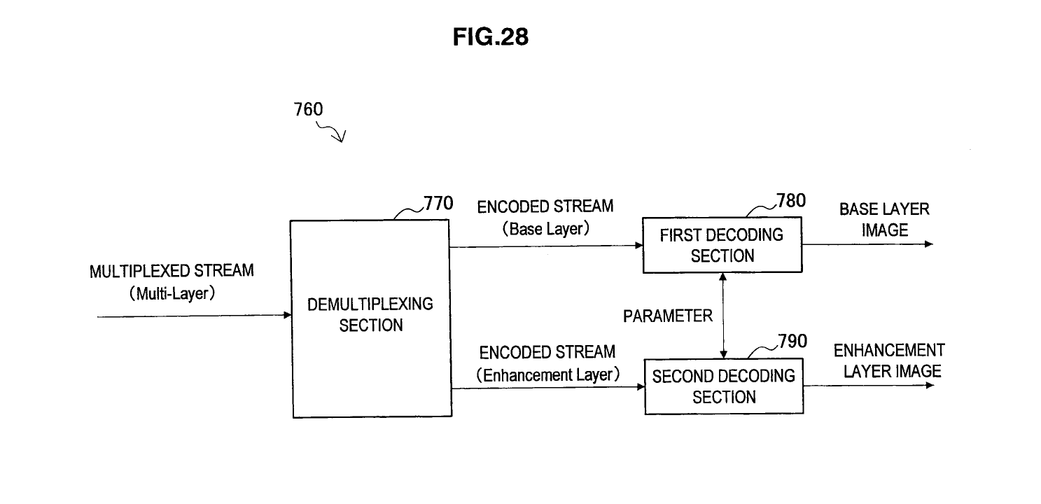

FIG. 28 is an explanatory diagram illustrating an image decoding process applied to the scalable codec described above. FIG. 28 shows a configuration of a scalable decoding device 760 as an example. The scalable decoding device 760 includes a demultiplexing section 770, a first decoding section 780, and a second decoding section 790.

The demultiplexing section 770 demultiplexes a multiplexed stream for multi-layer into an encoded stream for the base layer and an encoded stream for one or more enhancement layers. The first decoding section 780 decodes a base layer image from an encoded stream for the base layer. The second decoding section 730 decodes an enhancement layer image from an encoded stream for the enhancement layer.

The first decoding section 780 and the second decoding section 790 exemplified in FIG. 28 have a similar configuration to the image decoding device 60 according to an embodiment discussed earlier. For this reason, parameters inside the APS of the encoded stream for each layer may be accessed in units of parameter groups, and an image for each view may be decoded.

### 6. EXAMPLE APPLICATION

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

[6-1. First Example Application]

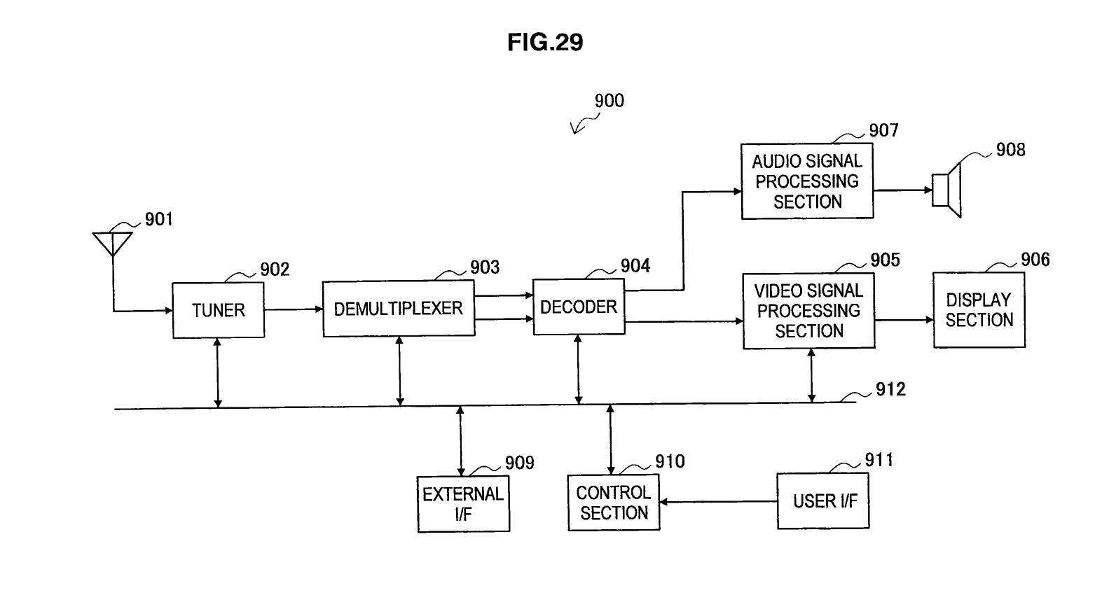

FIG. 29 is a block diagram showing an example of a schematic configuration of a television adopting the embodiment described above. A television 900 includes an antenna 901, a tuner 902, a demultiplexer 903, a decoder 904, an video signal processing section 905, a display section 906, an audio signal processing section 907, a speaker 908, an external interface 909, a control section 910, a user interface 911, and a bus 912.

The tuner 902 extracts a signal of a desired channel from broadcast signals received via the antenna 901, and demodulates the extracted signal. Then, the tuner 902 outputs an encoded bit stream obtained by demodulation to the demultiplexer 903. That is, the tuner 902 serves as transmission means of the televisions 900 for receiving an encoded stream in which an image is encoded.

The demultiplexer 903 separates a video stream and an audio stream of a program to be viewed from the encoded bit stream, and outputs each stream which has been separated to the decoder 904. Also, the demultiplexer 903 extracts auxiliary data such as an EPG (Electronic Program Guide) from the encoded bit stream, and supplies the extracted data to the control section 910. Additionally, the demultiplexer 903 may perform descrambling in the case the encoded bit stream is scrambled.

The decoder 904 decodes the video stream and the audio stream input from the demultiplexer 903. Then, the decoder 904 outputs video data generated by the decoding process to the video signal processing section 905. Also, the decoder 904 outputs the audio data generated by the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network. Further, the video signal processing section 905 may perform an additional process such as noise removal, for example, on the video data according to the setting. Furthermore, the video signal processing section 905 may generate an image of a GUI (Graphical User Interface) such as a menu, a button, a cursor or the like, for example, and superimpose the generated image on an output image.

The display section 906 is driven by a drive signal supplied by the video signal processing section 905, and displays a video or an image on an video screen of a display device (for example, a liquid crystal display, a plasma display, an OLED, or the like).

The audio signal processing section 907 performs reproduction processes such as D/A conversion and amplification on the audio data input from the decoder 904, and outputs audio from the speaker 908. Also, the audio signal processing section 907 may perform an additional process such as noise removal on the audio data.

The external interface 909 is an interface for connecting the television 900 and an external appliance or a network. For example, a video stream or an audio stream received via the external interface 909 may be decoded by the decoder 904. That is, the external interface 909 also serves as transmission means of the televisions 900 for receiving an encoded stream in which an image is encoded.

The control section 910 includes a processor such as a CPU (Central Processing Unit), and a memory such as an RAM (Random Access Memory), an ROM (Read Only Memory), or the like. The memory stores a program to be executed by the CPU, program data, EPG data, data acquired via a network, and the like. The program stored in the memory is read and executed by the CPU at the time of activation of the television 900, for example. The CPU controls the operation of the television 900 according to an operation signal input from the user interface 911, for example, by executing the program.

The user interface 911 is connected to the control section 910. The user interface 911 includes a button and a switch used by a user to operate the television 900, and a receiving section for a remote control signal, for example. The user interface 911 detects an operation of a user via these structural elements, generates an operation signal, and outputs the generated operation signal to the control section 910.

The bus 912 interconnects the tuner 902, the demultiplexer 903, the decoder 904, the video signal processing section 905, the audio signal processing section 907, the external interface 909, and the control section 910.

In the television 900 configured in this manner, the decoder 904 has a function of the image decoding device 60 according to the embodiment described above. Consequently, when decoding an image with the television 900, it is possible to avoid the redundant transmission of parameters and improve coding efficiency.

[6-2. Second Example Application]

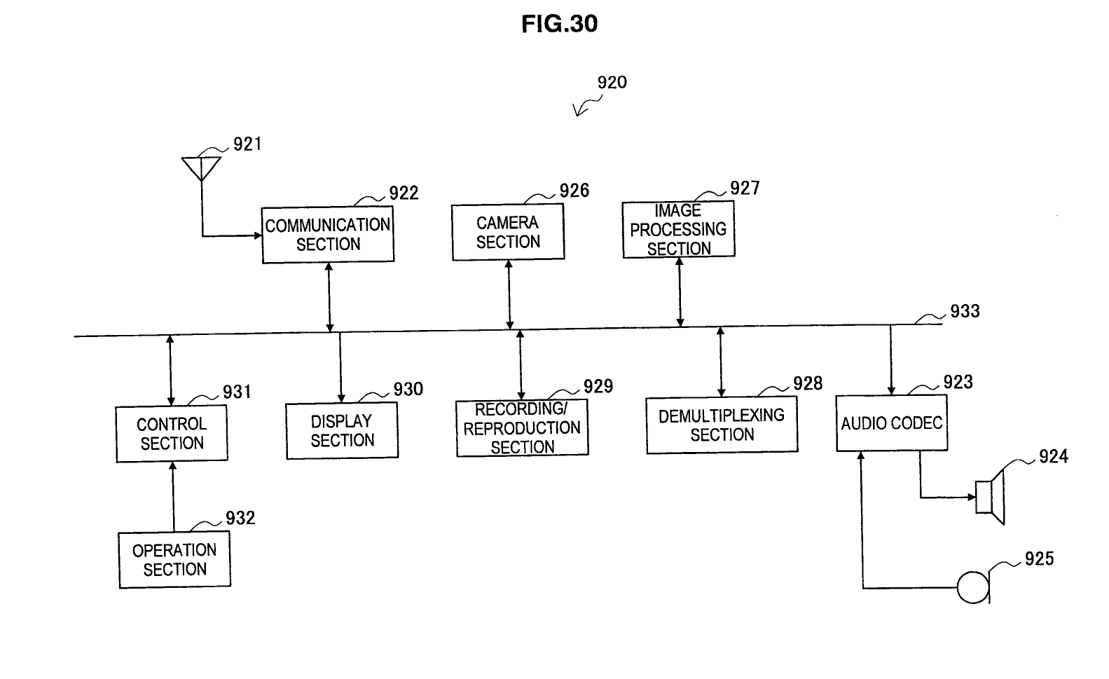

FIG. 30 is a block diagram showing an example of a schematic configuration of a mobile phone adopting the embodiment described above. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 interconnects the communication section 922, the audio codec 923, the camera section 926, the image processing section 927, the demultiplexing section 928, the recording/reproduction section 929, the display section 930, and the control section 931.

The mobile phone 920 performs operation such as transmission/reception of audio signal, transmission/reception of emails or image data, image capturing, recording of data, and the like, in various operation modes including an audio communication mode, a data communication mode, an image capturing mode, and a videophone mode.

In the audio communication mode, an analogue audio signal generated by the microphone 925 is supplied to the audio codec 923. The audio codec 923 converts the analogue audio signal into audio data, and A/D converts and compresses the converted audio data. Then, the audio codec 923 outputs the compressed audio data to the communication section 922. The communication section 922 encodes and modulates the audio data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal and generates audio data, and outputs the generated audio data to the audio codec 923. The audio codec 923 extends and D/A converts the audio data, and generates an analogue audio signal. Then, the audio codec 923 supplies the generated audio signal to the speaker 924 and causes the audio to be output.

Also, in the data communication mode, the control section 931 generates text data that makes up an email, according to an operation of a user via the operation section 932, for example. Moreover, the control section 931 causes the text to be displayed on the display section 930. Furthermore, the control section 931 generates email data according to a transmission instruction of the user via the operation section 932, and outputs the generated email data to the communication section 922. Then, the communication section 922 encodes and modulates the email data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal, restores the email data, and outputs the restored email data to the control section 931. The control section 931 causes the display section 930 to display the contents of the email, and also, causes the email data to be stored in the storage medium of the recording/reproduction section 929.

The recording/reproduction section 929 includes an arbitrary readable and writable storage medium. For example, the storage medium may be a built-in storage medium such as an RAM, a flash memory or the like, or an externally mounted storage medium such as a hard disk, a magnetic disk, a magneto-optical disk, an optical disc, an USB memory, a memory card, or the like.

Furthermore, in the image capturing mode, the camera section 926 captures an image of a subject, generates image data, and outputs the generated image data to the image processing section 927, for example. The image processing section 927 encodes the image data input from the camera section 926, and causes the encoded stream to be stored in the storage medium of the recording/reproduction section 929.

Furthermore, in the videophone mode, the demultiplexing section 928 multiplexes a video stream encoded by the image processing section 927 and an audio stream input from the audio codec 923, and outputs the multiplexed stream to the communication section 922, for example. The communication section 922 encodes and modulates the stream, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. These transmission signal and received signal may include an encoded bit stream. Then, the communication section 922 demodulates and decodes the received signal, restores the stream, and outputs the restored stream to the demultiplexing section 928. The demultiplexing section 928 separates a video stream and an audio stream from the input stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends and D/A converts the audio stream, and generates an analogue audio signal. Then, the audio codec 923 supplies the generated audio signal to the speaker 924 and causes the audio to be output.

In the mobile phone 920 configured in this manner, the image processing section 927 has a function of the image encoding device 10 and the image decoding device 60 according to the embodiment described above. Accordingly, also in the case of encoding and decoding an image in the mobile phone 920, it is possible to enhance the parallelism of deblocking filter processes and ensure high-speed processing.

[6-3. Third Example Application]

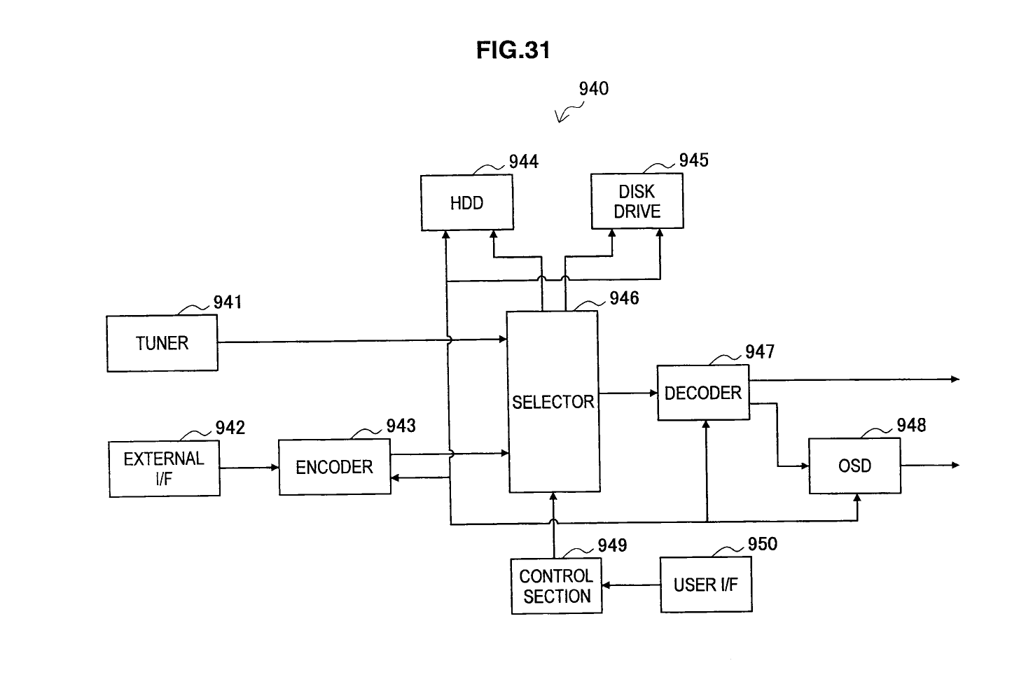

FIG. 31 is a block diagram showing an example of a schematic configuration of a recording/reproduction device adopting the embodiment described above. A recording/reproduction device 940 encodes, and records in a recording medium, audio data and video data of a received broadcast program, for example. The recording/reproduction device 940 may also encode, and record in the recording medium, audio data and video data acquired from another device, for example. Furthermore, the recording/reproduction device 940 reproduces, using a monitor or a speaker, data recorded in the recording medium, according to an instruction of a user, for example. At this time, the recording/reproduction device 940 decodes the audio data and the video data.

The recording/reproduction device 940 includes a tuner 941, an external interface 942, an encoder 943, an HDD (Hard Disk Drive) 944, a disc drive 945, a selector 946, a decoder 947, an OSD (On-Screen Display) 948, a control section 949 and a user interface 950.

The tuner 941 extracts a signal of a desired channel from broadcast signals received via an antenna (not shown), and demodulates the extracted signal. Then, the tuner 941 outputs an encoded bit stream obtained by demodulation to the selector 946. That is, the tuner 941 serves as transmission means of the recording/reproduction device 940.

The external interface 942 is an interface for connecting the recording/reproduction device 940 and an external appliance or a network. For example, the external interface 942 may be an IEEE 1394 interface, a network interface, an USB interface, a flash memory interface, or the like. For example, video data and audio data received by the external interface 942 are input to the encoder 943. That is, the external interface 942 serves as transmission means of the recording/reproduction device 940.

In the case the video data and the audio data input from the external interface 942 are not encoded, the encoder 943 encodes the video data and the audio data. Then, the encoder 943 outputs the encoded bit stream to the selector 946.

The HDD 944 records in an internal hard disk an encoded bit stream, which is compressed content data of a video or audio, various programs, and other pieces of data. Also, the HDD 944 reads these pieces of data from the hard disk at the time of reproducing a video or audio.

The disc drive 945 records or reads data in a recording medium that is mounted. A recording medium that is mounted on the disc drive 945 may be a DVD disc (a DVD-Video, a DVD-RAM, a DVD-R, a DVD-RW, a DVD+, a DVD+RW, or the like), a Blu-ray (registered trademark) disc, or the like, for example.

The selector 946 selects, at the time of recording a video or audio, an encoded bit stream input from the tuner 941 or the encoder 943, and outputs the selected encoded bit stream to the HDD 944 or the disc drive 945. Also, the selector 946 outputs, at the time of reproducing a video or audio, an encoded bit stream input from the HDD 944 or the disc drive 945 to the decoder 947.

The decoder 947 decodes the encoded bit stream, and generates video data and audio data. Then, the decoder 947 outputs the generated video data to the OSD 948. Also, the decoder 904 outputs the generated audio data to an external speaker.

The OSD 948 reproduces the video data input from the decoder 947, and displays a video. Also, the OSD 948 may superimpose an image of a GUI, such as a menu, a button, a cursor or the like, for example, on a displayed video.

The control section 949 includes a processor such as a CPU, and a memory such as an RAM or an ROM. The memory stores a program to be executed by the CPU, program data, and the like. A program stored in the memory is read and executed by the CPU at the time of activation of the recording/reproduction device 940, for example. The CPU controls the operation of the recording/reproduction device 940 according to an operation signal input from the user interface 950, for example, by executing the program.

The user interface 950 is connected to the control section 949. The user interface 950 includes a button and a switch used by a user to operate the recording/reproduction device 940, and a receiving section for a remote control signal, for example. The user interface 950 detects an operation of a user via these structural elements, generates an operation signal, and outputs the generated operation signal to the control section 949.

In the recording/reproduction device 940 configured in this manner, the encoder 943 has a function of the image encoding device 10 according to the embodiment described above. Also, the decoder 947 has a function of the image decoding device 60 according to the embodiment described above. Consequently, when encoding and decoding an image with the recording/reproduction device 940, it is possible to avoid the redundant transmission of parameters and improve coding efficiency.

[6-4. Fourth Example Application]

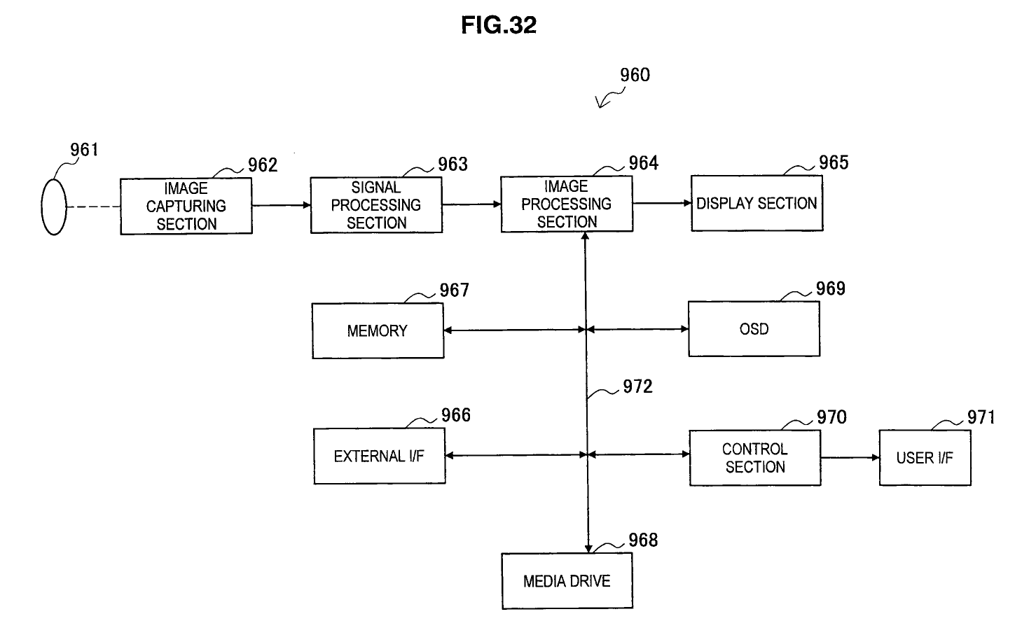

FIG. 32 is a block diagram showing an example of a schematic configuration of an image capturing device adopting the embodiment described above. An image capturing device 960 captures an image of a subject, generates an image, encodes the image data, and records the image data in a recording medium.

The image capturing device 960 includes an optical block 961, an image capturing section 962, a signal processing section 963, an image processing section 964, a display section 965, an external interface 966, a memory 967, a media drive 968, an OSD 969, a control section 970, a user interface 971, and a bus 972.

The optical block 961 is connected to the image capturing section 962. The image capturing section 962 is connected to the signal processing section 963. The display section 965 is connected to the image processing section 964. The user interface 971 is connected to the control section 970. The bus 972 interconnects the image processing section 964, the external interface 966, the memory 967, the media drive 968, the OSD 969, and the control section 970.

The optical block 961 includes a focus lens, an aperture stop mechanism, and the like. The optical block 961 forms an optical image of a subject on an image capturing surface of the image capturing section 962. The image capturing section 962 includes an image sensor such as a CCD, a CMOS or the like, and converts by photoelectric conversion the optical image formed on the image capturing surface into an image signal which is an electrical signal. Then, the image capturing section 962 outputs the image signal to the signal processing section 963.

The signal processing section 963 performs various camera signal processes, such as knee correction, gamma correction, color correction and the like, on the image signal input from the image capturing section 962. The signal processing section 963 outputs the image data after the camera signal process to the image processing section 964.

The image processing section 964 encodes the image data input from the signal processing section 963, and generates encoded data. Then, the image processing section 964 outputs the generated encoded data to the external interface 966 or the media drive 968. Also, the image processing section 964 decodes encoded data input from the external interface 966 or the media drive 968, and generates image data. Then, the image processing section 964 outputs the generated image data to the display section 965. Also, the image processing section 964 may output the image data input from the signal processing section 963 to the display section 965, and cause the image to be displayed. Furthermore, the image processing section 964 may superimpose data for display acquired from the OSD 969 on an image to be output to the display section 965.

The OSD 969 generates an image of a GUI, such as a menu, a button, a cursor or the like, for example, and outputs the generated image to the image processing section 964.

The external interface 966 is configured as an USB input/output terminal, for example. The external interface 966 connects the image capturing device 960 and a printer at the time of printing an image, for example. Also, a drive is connected to the external interface 966 as necessary. A removable medium, such as a magnetic disk, an optical disc or the like, for example, is mounted on the drive, and a program read from the removable medium may be installed in the image capturing device 960. Furthermore, the external interface 966 may be configured as a network interface to be connected to a network such as a LAN, the Internet or the like. That is, the external interface 966 serves as transmission means of the image capturing device 960.

A recording medium to be mounted on the media drive 968 may be an arbitrary readable and writable removable medium, such as a magnetic disk, a magneto-optical disk, an optical disc, a semiconductor memory or the like, for example. Also, a recording medium may be fixedly mounted on the media drive 968, configuring a non-transportable storage section such as a built-in hard disk drive or an SSD (Solid State Drive), for example.

The control section 970 includes a processor such as a CPU, and a memory such as an RAM or an ROM. The memory stores a program to be executed by the CPU, program data, and the like. A program stored in the memory is read and executed by the CPU at the time of activation of the image capturing device 960, for example. The CPU controls the operation of the image capturing device 960 according to an operation signal input from the user interface 971, for example, by executing the program.

The user interface 971 is connected to the control section 970. The user interface 971 includes a button, a switch and the like used by a user to operate the image capturing device 960, for example. The user interface 971 detects an operation of a user via these structural elements, generates an operation signal, and outputs the generated operation signal to the control section 970.

In the image capturing device 960 configured in this manner, the image processing section 964 has a function of the image encoding device 10 and the image decoding device 60 according to the embodiment described above. Consequently, when encoding and decoding an image with the image capturing device 960, it is possible to avoid the redundant transmission of parameters and improve coding efficiency.

### 7. CONCLUSION

The foregoing uses FIGS. 1 to 32 to describe in detail an image encoding device 10 and an image decoding device 60 according to an embodiment. According to the foregoing embodiment, the redundant transmission of parameters is avoided in the case of including parameters with mutually different properties in a shared parameter set. For example, parameters that may be included in a parameter set are grouped according to some criterion. The parameters belonging to each parameter group are encoded in units of parameter groups inside a parameter set only at timings when updating is necessary. Each parameter group is assigned a sub-identifier set separately from the parameter set identifier. When decoding individual slices in an image, these parameters are referenced using a sub-identifier. Consequently, it becomes possible to flexibly encode or not encode parameters with mutually different properties inside one parameter set according to the need to update, without increasing the types of parameter sets, such as, for example, without increasing the NAL unit types whose number is limited under the specification. For this reason, it is possible to avoid the redundant transmission of parameters, and improve coding efficiency.

Also, in the present embodiment, a criterion related to parameter update frequency may be used as the criterion for grouping parameters. A criterion related to parameter update frequency may be, for example, the parameter update frequency itself, or a criterion according to types of related coding tools or the likelihood of parameter reuse. In this way, by grouping parameters using a criterion related to parameter update frequency, it becomes possible to encode parameters in timely and efficient units of groups according to parameter update requirements, without excessively subdividing the groups. Consequently, the increase in sub-identifiers for referencing parameters in respective groups is prevented from adversely affecting coding efficiency.

In addition, in the case in which a combination ID related to a combination of sub-identifiers is used in order to reference parameters in respective groups, it is possible to even further reduce the slice header rate.

Note that this specification describes an example in which the various parameters are multiplexed into the header of the encoded stream and transmitted from the encoding side to the decoding side. However, the technique of transmitting such parameter is not limited to such an example. For example, each parameter may also be transmitted or recorded as separate data associated with an encoded bit stream without being multiplexed into the encoded bit stream. Herein, the term “associated” means that images included in the bit stream (also encompassing partial images such as slices or blocks) and information corresponding to those images can be linked at the time of decoding. In other words, information may also be transmitted on a separate transmission channel from an image (or bit stream). Also, the information may be recorded to a separate recording medium (or a separate recording area on the same recording medium) from the image (or bit stream). Furthermore, information and images (or bit streams) may be associated with each other in arbitrary units such as multiple frames, single frames, or portions within frames, for example.

The foregoing thus describes preferred embodiments of the present disclosure in detail and with reference to the attached drawings. However, the technical scope of the present disclosure is not limited to such examples. It is clear to persons ordinarily skilled in the technical field to which the present disclosure belongs that various modifications or alterations may occur insofar as they are within the scope of the technical ideas stated in the claims, and it is to be understood that such modifications or alterations obviously belong to the technical scope of the present disclosure.

Additionally, the present disclosure may also be configured as below.

(1)

An image processing device including:

an acquisition section that acquires, from a parameter set of an encoded stream, a parameter group including one or more parameters used when encoding or decoding an image, and a sub-identifier that identifies the parameter group; and

a decoding section that decodes the image using a parameter in the parameter group that is referenced using the sub-identifier acquired by the acquisition section.

(2)

The image processing device according to (1),

wherein the parameter group groups parameters according to update frequency when decoding the image.

(3)

The image processing device according to (1),

wherein the parameter group groups parameters according to coding tools used when decoding the image.

(4)

The image processing device according to (3),

wherein the coding tools include at least two of a quantization matrix, an adaptive loop filter, a sample adaptive offset, and an adaptive interpolation filter.

(5)

The image processing device according to (1),

wherein the parameter group groups parameters according to a likelihood of reuse of each parameter.

(6)

The image processing device according to any one of (1) to (5),

wherein the decoding section uses the sub-identifier specified in a slice header of the encoded stream to reference a parameter that is set for a corresponding slice.

(7)

The image processing device according to any one of (1) to (5),

wherein the acquisition section acquires, from the encoded stream, a combination identifier associated with a combination of a plurality of the sub-identifiers, and

wherein the decoding section uses the sub-identifiers specified in a slice header of the encoded stream and associated with the combination identifier to reference parameters that are set for a corresponding slice.

(8)

The image processing device according to any one of (1) to (7),

wherein the parameter set is a network abstraction layer (NAL) unit that differs from a sequence parameter set and a picture parameter set, and

wherein the sub-identifier is an identifier that differs from a parameter set identifier identifying the NAL unit.

(9)

The image processing device according to (8),

wherein the parameter set is an adaptation parameter set (APS), and

wherein the parameter set identifier is an APS_ID.

(10)

An image processing method including:

acquiring, from a parameter set of an encoded stream, a parameter group including one or more parameters used when encoding or decoding an image, and a sub-identifier that identifies the parameter group; and

decoding the image using a parameter in the parameter group that is referenced using the acquired sub-identifier.

(11)

An image processing device including:

a setting unit that sets a parameter group including one or more parameters used when encoding or decoding an image, and a sub-identifier that identifies the parameter group; and

an encoding section that inserts the parameter group and the sub-identifier set by the setting unit inside a parameter set of an encoded stream generated by encoding the image.

(12)

The image processing device according to (11),

wherein the parameter group groups parameters according to update frequency when decoding the image.

(13)

The image processing device according to (11),

wherein the parameter group groups parameters according to coding tools used when decoding the image.

(14)

The image processing device according to (13),

wherein the coding tools include at least two of a quantization matrix, an adaptive loop filter, a sample adaptive offset, and an adaptive interpolation filter.

(15)

The image processing device according to (11),

wherein the parameter group groups parameters according to a likelihood of reuse of each parameter.

(16)

The image processing device according to any one of (11) to (15),

wherein the encoding section inserts, into a slice header of the encoded stream, the sub-identifier used in order to reference a parameter that is set for a corresponding slice.

(17)

The image processing device according to any one of (11) to (15),

wherein the setting unit sets a combination identifier associated with a combination of a plurality of the sub-identifiers, and

wherein the encoding section inserts, into a slice header of the encoded stream, the combination identifier associated with the sub-identifiers used in order to reference parameters that are set for a corresponding slice.

(18)

The image processing device according to any one of (11) to (17),

wherein the parameter set is a network abstraction layer (NAL) unit that differs from a sequence parameter set and a picture parameter set, and

wherein the sub-identifier is an identifier that differs from a parameter set identifier identifying the NAL unit.

(19)

The image processing device according to (18),

wherein the parameter set is an adaptation parameter set (APS), and

wherein the parameter set identifier is an APS_ID.

(20)

An image processing method including:

setting a parameter group including one or more parameters used when encoding or decoding an image, and a sub-identifier that identifies the parameter group; and

inserting the set parameter group and the set sub-identifier inside a parameter set of an encoded stream generated by encoding the image.

### REFERENCE SIGNS LIST

10 image processing device (image encoding device)
60 image processing device (image decoding device)

1. An image processing device comprising:
an acquisition section that acquires, from a parameter set of an encoded stream, a parameter group including one or more parameters used when encoding or decoding an image, and a sub-identifier that identifies the parameter group; and
a decoding section that decodes the image using a parameter in the parameter group that is referenced using the sub-identifier acquired by the acquisition section.

2. The image processing device according to claim 1,
wherein the parameter group groups parameters according to update frequency when decoding the image.

3. The image processing device according to claim 1,
wherein the parameter group groups parameters according to coding tools used when decoding the image.

4. The image processing device according to claim 3,
wherein the coding tools include at least two of a quantization matrix, an adaptive loop filter, a sample adaptive offset, and an adaptive interpolation filter.

5. The image processing device according to claim 1,
wherein the parameter group groups parameters according to a likelihood of reuse of each parameter.

6. The image processing device according to claim 1,
wherein the decoding section uses the sub-identifier specified in a slice header of the encoded stream to reference a parameter that is set for a corresponding slice.

7. The image processing device according to claim 1,
wherein the acquisition section acquires, from the encoded stream, a combination identifier associated with a combination of a plurality of the sub-identifiers, and
wherein the decoding section uses the sub-identifiers specified in a slice header of the encoded stream and associated with the combination identifier to reference parameters that are set for a corresponding slice.

8. The image processing device according to claim 1,
wherein the parameter set is a network abstraction layer (NAL) unit that differs from a sequence parameter set and a picture parameter set, and
wherein the sub-identifier is an identifier that differs from a parameter set identifier identifying the NAL unit.

9. The image processing device according to claim 8,
wherein the parameter set is an adaptation parameter set (APS), and
wherein the parameter set identifier is an APS_ID.

10. An image processing method comprising:
acquiring, from a parameter set of an encoded stream, a parameter group including one or more parameters used when encoding or decoding an image, and a sub-identifier that identifies the parameter group; and
decoding the image using a parameter in the parameter group that is referenced using the acquired sub-identifier.

11. An image processing device comprising:
a setting unit that sets a parameter group including one or more parameters used when encoding or decoding an image, and a sub-identifier that identifies the parameter group; and
an encoding section that inserts the parameter group and the sub-identifier set by the setting unit inside a parameter set of an encoded stream generated by encoding the image.

12. The image processing device according to claim 11,
wherein the parameter group groups parameters according to update frequency when decoding the image.

13. The image processing device according to claim 11,
wherein the parameter group groups parameters according to coding tools used when decoding the image.

14. The image processing device according to claim 13,
wherein the coding tools include at least two of a quantization matrix, an adaptive loop filter, a sample adaptive offset, and an adaptive interpolation filter.

15. The image processing device according to claim 11,
wherein the parameter group groups parameters according to a likelihood of reuse of each parameter.

16. The image processing device according to claim 11,
wherein the encoding section inserts, into a slice header of the encoded stream, the sub-identifier used in order to reference a parameter that is set for a corresponding slice.

17. The image processing device according to claim 11,
wherein the setting unit sets a combination identifier associated with a combination of a plurality of the sub-identifiers, and
wherein the encoding section inserts, into a slice header of the encoded stream, the combination identifier associated with the sub-identifiers used in order to reference parameters that are set for a corresponding slice.

18. The image processing device according to claim 11,
wherein the parameter set is a network abstraction layer (NAL) unit that differs from a sequence parameter set and a picture parameter set, and
wherein the sub-identifier is an identifier that differs from a parameter set identifier identifying the NAL unit.

19. The image processing device according to claim 18,
wherein the parameter set is an adaptation parameter set (APS), and
wherein the parameter set identifier is an APS_ID.

20. An image processing method comprising:
setting a parameter group including one or more parameters used when encoding or decoding an image, and a sub-identifier that identifies the parameter group; and
inserting the set parameter group and the set sub-identifier inside a parameter set of an encoded stream generated by encoding the image.
